(19) United States
(12) Patent Application Publication
(10) Pub. No.: US 2024/0283346 A1
(43) Pub. Date: Aug. 22, 2024

(54) FLUX-MODULATED MACHINE

(71) Applicant: NANYANG TECHNOLOGICAL UNIVERSITY, Singapore (SG)

(72) Inventors: Hao CHEN, Singapore (SG); Ho Tin LEE, Singapore (SG)

(73) Assignee: NANYANG TECHNOLOGICAL UNIVERSITY, Singapore (SG)

(21) Appl. No.: 18/566,514

(22) PCT Filed: Jun. 9, 2022
(86) PCT No.: PCT/SG2022/050397

§ 371 Date: Dec. 1, 2023

(30) Foreign Application Priority Data
Jun. 14, 2021 (SG) 10202106341Y

(51) Int. Cl. H02K 49/10; F03D 15/00

(52) U.S. Cl. CPC H02K 49/102; F03D 15/00; F05B 2260/404

(57) ABSTRACT

An apparatus comprising a magnetic-geared machine component; and a Vernier machine component; wherein the magnetic-geared machine component is ar-ranged concentrically with the Vernier machine component; and wherein each of the magnetic-geared machine component and the Vernier machine compo-nent have flux modulation functionality.

### TECHNICAL FIELD

The present invention relates, in general terms, to a flux-modulated machine, more particularly relates to a dual flux-modulated machine.

### BACKGROUND

Electric machines are the key enabling technology for wind power generation. The required basic performance metrics of an electric machine for wind power generation include high torque/power density, high efficiency, high reliability, low cost, as well as flexible controllability.

With the development of permanent magnet materials and power electronic devices, permanent magnet synchronous machines (PMSMs) instead of induction machines became the most promising candidate in wind power generation applications (especially in higher power rating and direct-drive applications) due to their inherently high torque density, high efficiency, and high reliability. However, a reduction gearbox is typically required to match the low-speed wind and the high-speed generator, which leads to heaviness and bulkiness, noise and vibration, regular maintenance requirement, reduced efficiency, and high cost.

With the aim to eliminate the gearbox by improving torque density associated techniques, a number of new entrants/variants of PMSMs based on flux modulation theory are emerging for gearless direct-drive wind power generation applications. It was found that the presented magnetic-geared machine outperforms the counterpart machine in terms of torque density and efficiency. However, the multi-slot structure brings challenges in winding coils and manufacturing process.

It would be desirable to overcome all or at least one of the above-described problems.

### SUMMARY

Disclosed herein is an apparatus comprising :
a magnetic-geared machine component; and
a Vernier machine component;
wherein the magnetic-geared machine component is arranged concentrically with the Vernier machine component; and
wherein each of the magnetic-geared machine component and the Vernier machine component have flux modulation functionality.

In some embodiments, the apparatus further comprises:
a stator comprising an outer stator that comprises outer stator teeth having at least one first winding arranged thereon, and an inner stator that comprises inner stator teeth having at least one second winding arranged thereon; and
a rotor comprising an outer rotor that comprises a plurality of permanent magnets alternating with a plurality of steel segments, and an inner rotor about which the outer rotor is arranged.

Disclosed herein is also a flux modulation apparatus comprising:
a stator comprising outer stator teeth having at least one first winding arranged thereon and inner stator teeth comprises at least one second winding arranged thereon;
an outer rotor comprising a plurality of permanent magnets alternating with a plurality of steel segments; and
an inner rotor about which the outer rotor is arranged,
wherein the at least one first winding, the plurality of permanent magnets and the inner rotor form a magnetic-geared machine component, and the at least one second winding, the inner stator teeth and the outer rotor form a Vernier machine, and wherein each of the magnetic-geared machine component and the Vernier machine component have flux modulation functionality.

In some embodiments, the plurality of permanent magnets are circumferentially magnetized and polarity of the plurality of permanent magnets alternates around the rotor.

In some embodiments, the magnetic-geared machine component comprises the at least one first winding, the plurality of permanent magnets of the outer rotor, and the inner rotor; and wherein the Vernier machine component comprises the at least one second winding, the inner stator teeth, and the outer rotor.

In some embodiments, salient poles of the inner rotor provide the flux modulation functionality of the magnetic-geared machine component.

In some embodiments, the inner stator teeth provide the flux modulation functionality of the Vernier machine component.

In some embodiments, the inner stator comprises inner stator slots that are open slots.

In some embodiments, the inner stator teeth comprises open slot teeth.

In some embodiments, the at least one first winding is decoupled from the at least one second winding.

In some embodiments, a pole-pair number of each first winding differs from a pole-pair number of each second winding.

In some embodiments, the inner rotor and the outer rotor are connected to respective sets of wind turbine blades.

### BRIEF DESCRIPTION OF THE DRAWINGS

Embodiments of the present invention will now be described, by way of non-limiting example, with reference to the drawings in which:

FIG. 1 illustrates a conventional contra-rotating wind generator system based on bevel-planetary gear system;

FIG. 2 illustrates a gearless direct-drive contra-rotating wind generator system;

FIG. 3 illustrates a topology of the proposed integrated flux-modulated machine;

FIG. 4a shows induced voltage when only winding II is excited in a coupled design;

FIG. 4b shows induced voltage when only winding II is excited in a decoupled design;

FIG. 5 shows a doubly-fed flux-bidirectional modulated machine;

FIG. 6a shows the no-load magnetic flux density waveforms in the outer air-gap of the two investigated machines;

FIG. 6b shows the no-load magnetic flux density waveforms in the associated harmonic spectra of the two investigated machines;

FIG. 7 shows the no-load back-EMF waveforms of the benchmark machine and presented machine;

FIG. 8 illustrates torque profiles of the benchmark machine and presented machine;

FIGS. 9a-9d show prototype of stator, outer rotor, inner rotor and assembly, respectively;

FIGS. 10a and 10b illustrate assembling process of the prototype in exploded view and cross-sectional view, respectively;

FIG. 11 illustrates effects of the drills in the outer rotor on the induced back-EMF;

FIG. 12a illustrates test hardware setup;

FIG. 12b shows a diagram of measurement;

FIG. 13a shows experimental results of no-load back-EMF of Winding I in comparison with simulation results;

FIG. 13b shows experimental results of no-load back-EMF of Winding II in comparison with simulation results;

FIG. 14 illustrates DC voltage and current generated from Winding I;

FIG. 15 illustrates DC voltage and current generated from Winding II;

FIG. 16 shows experimental results of rotor average toque versus current;

FIG. 17 illustrates a schematic diagram of a DMP machine in CVT systems of HEVs;

FIGS. 18a-18d show conventional DMP machine, DMP machine with spoke-type PMs, DMP machine with reluctance rotor, and DMP machine with open slots, respectively;

FIGS. 19a-19d illustrate flux lines and flux density distribution of the four investigated machines under no-load condition for M-I, M-II, M-III, and M-IV respectively.

FIGS. 20a-20c illustrate air gap flux density for profiles, harmonic spectrum of M-I, M-II, and M-III, and harmonic spectrum of M-IV respectively.

FIGS. 21a and 21b show no-load back-EMF profiles for outer winding, and inner winding, respectively.

FIG. 22a shows magnetically-geared machine (MGM) portion torque with only outer winding excitation;

FIG. 22b show PMSM/Vernier portion torque with only outer winding excitation;

FIGS. 23a and 23b show zoom-in flux lines for M-III and M-IV, respectively;

FIG. 24a shows flux lines of the Vernier portion without inner robot;

FIG. 24b shows flux lines of the Vernier portion with inner robot;

FIGS. 25a and 25b show Vernier portion outputs for back-EMF and output torque, respectively;

FIG. 26 shows parametric model for the proposed machine;

FIG. 27 illustrates a flow chart of the automated optimization procedure;

FIG. 28a shows optimization results of torque objective vs. efficiency;

FIG. 28b shows optimization results of torque objective vs. power factor of outer winding;

FIG. 29 illustrates prototype and experimental setup;

FIG. 30 illustrates measured current and voltage for decoupling validation;

FIGS. 31a and 31b illustrate measured back-EMF for outer winding and inner winding, respectively;

FIGS. 32a shows simulated and measured results of inner rotor torque vs. current control angle;

FIGS. 32b shows simulated and measured results of outer rotor torque vs. current control angle;

FIG. 33a shows simulated and measured results of output torque vs. outer winding current;

FIG. 33b shows simulated and measured results of output torque vs. inner winding current; and

FIG. 33c shows simulated and measured results of output torque vs. both winding currents.

### DETAILED DESCRIPTION

Described is an investigation and evaluation of an integrated flux-modulated machine for wind power generation—an embodiment of the invention. The integrated flux-modulated machine has two rotors which function as two contra-rotating rotors connected to two sets of turbine blades. Hence, compared to conventional wind generators, more wind energy could be captured by this wind power generation system. Moreover, the integrated machine comprises two sets of stator windings. By regulating the currents in these windings, a dual maximum power point tracking (MPPT) control strategy is achievable. As a result, wind power conversion efficiency is further improved. Moreover, this wind power generation system exhibits the advantage of high torque/power density due to the enhanced magnetic-gearing effect involved in the integrated flux-modulated machine. Hence, this machine is more suitable for direct-drive wind power generation, where the reliability is improved without the maintenance issues related to mechanical gearboxes. The topology and operating principle of the investigated machine are demonstrated in detail. A decoupled design for the two sets of windings is investigated, and a general rule to achieve decoupled windings by appropriate slot-pole combination selection is illustrated. The advantages of the investigated machine are confirmed in comparison to a benchmark machine. Finally, for the investigated flux-modulated machines the simulation results are verified by experimental results.

Electric machines are the key enabling technology for wind power generation. The required basic performance metrics of electric machine for wind power generation systems include high torque/power density, high efficiency, high reliability, low cost, as well as flexible controllability. To target these objectives mentioned-above, various types of electric machines have been developed as wind generators. Compared to conventional squirrel-cage induction machines and wound-rotor induction machines, doubly-fed induction machines have been widely adopted in commercial wind turbines, e.g., Vestas V80 (2.0 MW) and Siemens/Gamesa 145 (5.0 MW), due to the advantages of improved reliability, reduced power rating of power converter, flexible control of active and reactive power, and improved low voltage ride through. However, such machines suffer from low torque density, low efficiency, and relatively complicated power control. With the development of permanent magnet materials and power electronic devices, PMSMs instead of induction machines became the most promising candidate in wind power generation applications (especially in higher power rating and direct-drive applications) due to their inherently high torque density, high efficiency, and high reliability. Since the output torque of conventional PMSMs is limited by the machine size, such generators, e.g., Vestas V90 (2.0 MW), are typically operating at high speed in order to improve the power density. Hence, a reduction gearbox is typically required to match the low-speed wind and the high-speed generator, which leads to added system mass and size, noise and vibration, regular maintenance requirement, reduced efficiency, and high cost.

With the aim to eliminate the gearbox by improving torque density associated techniques, a number of new entrants/variants of PMSMs based on flux modulation theory are emerging for gearless direct-drive wind power generation applications, including flux-switching PM machines, flux-reversal PM machines, Vernier PM machines, and magnetically-geared PM machines. Among them, the magnetically-geared PM machines outperform other counterparts in terms of the torque density, PM utilization ratio, cost, and produced power quality, which makes them more suitable for direct-drive wind generators. For some magnetically-geared PM machines for direct-drive wind power generation, a magnetic gear is incorporated into an inner-rotor PMSM. Hence, there is a steady torque boost as a reduction mechanical gear does, leading to achieving a low-speed high-torque direct-drive function (in this case, up to 9.9M Nm was achieved with a total active mass of less than 65 tons). This is favorable for wind power generation applications.

It was found that the some magnetically-geared machines outperform the PMSM counterpart across the entire range of torque density and efficiency. It was shown that by utilizing the modulation-ring structure, this machine can modulate the high-speed rotating armature field of the two stators to match the low-speed rotating PM field of the rotor. Hence, this machine readily achieves the low-speed high torque goal. However, the multi-slot structure brings challenges in winding coils and in manufacturing. Another double-stator magnetically-geared machine was considered, where the inner stator includes the field windings while the armature windings are located in the outer stator. The pole-pair number of the inner excitation sources could be flexibly changed through injecting variable DC filed currents, which is desirable to match the varying wind speed. Moreover, an effective magnetic field adjustment could be achieved by regulating the dominant pole-pair flux components. Hence, the torque density and flux-regulation capability of this machine are both improved.

Building upon the existing magnetically-geared machines, this invention brings new contributions by presenting an integrated flux-modulated machine embodiments of which can be used for direct-drive wind power generation. The integrated flux-modulated machine has two rotors which function as two contra-rotating rotors connected to two sets of turbine blades. In particular, the inner rotor and the outer rotor are connected to respective sets of wind turbine blades. Hence, more wind energy could be captured by this wind power generation system. The integrated machine comprises two sets of stator windings. By regulating the currents in these windings, dual maximum power point tracking (MPPT) control strategy could be achieved. As a result, the wind power conversion efficiency is further improved. Moreover, the integrated flux-modulated machine exhibits the advantage of high torque density due to the enhanced magnetic-gearing effect.

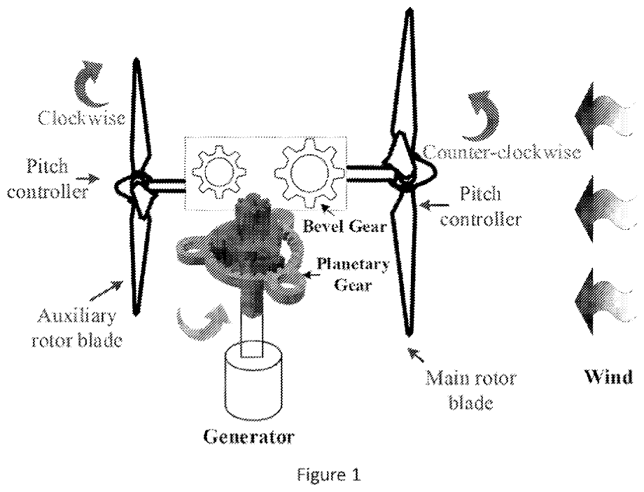

The proposed contra-rotating wind power system is now described. This system was developed for a 30 kw contra-rotating wind turbine, as shown in FIG. 1, which shows a conventional contra-rotating wind generator system based on a bevel-planetary gear system. The combined torque from the two contra-rotating rotors is transmitted to the sun gear through the bevel-planetary gearbox. Then it drives the generator in the vertical axis to generate electricity. It was shown that with such two contra-rotating blades, up to 40% more wind energy could be captured and converted into electric energy, compared to conventional wind turbines with a single set of blades. However, the mechanical gearbox inevitably suffers from the drawbacks of regular maintenance requirement, bulkiness, acoustic noise, low reliability, and high cost, etc. Moreover, the torque split ratio on the two rotor shafts remains constant due to the fixed gear ratio of such gearbox. As a result, the MPPT control strategy on both rotor shafts is not feasible.

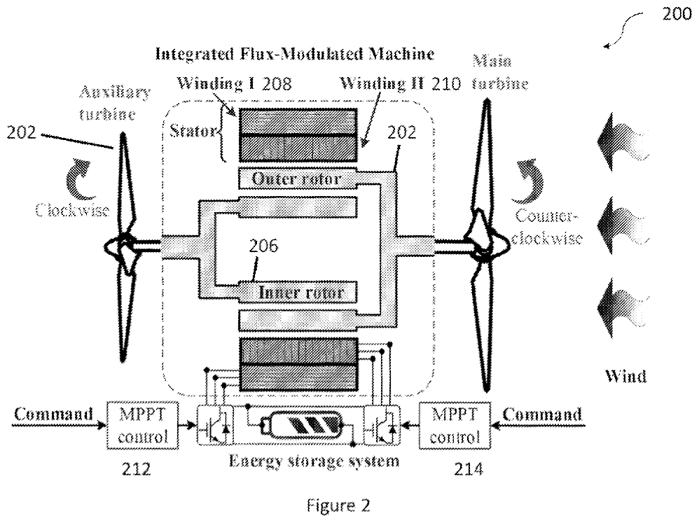

To solve the issues mentioned-above, a gearless direct-drive contra-rotating wind power generation system based on an integrated flux-modulated machine 200 is presented, as shown in FIG. 2. As can be seen, the outer rotor 202, rotating in the counter-clockwise direction, is directly connected to the main turbine, while the inner rotor 206, rotating in the clockwise direction, is also directly connected to the auxiliary turbine 204 to capture more wind energy. Moreover, due to the fact that the two rotors 202 and 206 are rotating in opposite directions, the relative angular speed of the two rotors and the relative angular velocity of the rotating magnetic fields in the air-gap are increased. Hence, the frequency of the induced voltage/current is increased based on Faraday's Law, which is desirable for low-speed direct-drive wind power generators. In addition, the torques on the two rotors can be flexibly controlled by the two sets of windings, i.e., Winding I 208 and Winding II 210, respectively. Hence, dual MPPT control strategy (see 212 and 214) could be achieved, which would maximize the wind energy conversion efficiency.

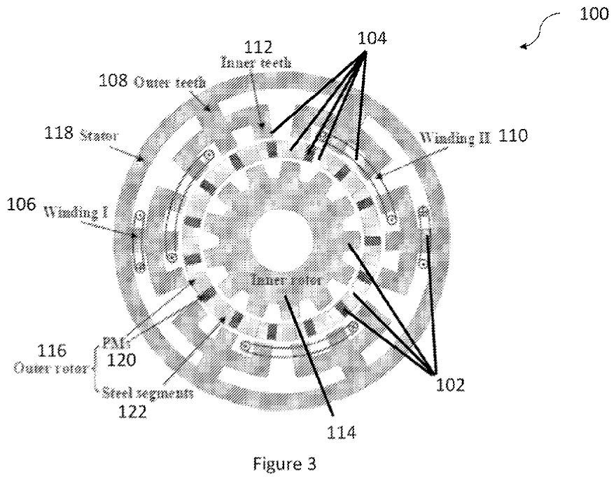

Various topologies for an integrated flux-modulated machine are described herein. The topology of an example integrated flux-modulated machine 100 is shown in FIG. 3. The machine 100 comprises:
a magnetic-geared machine component 102; and
a Vernier machine component 104;
wherein the magnetic-geared machine component 102 is arranged concentrically with the Vernier machine component 104; and
wherein each of the magnetic-geared machine component 102 and the Vernier machine component 104 have flux modulation functionality.

There are two sets of windings in the stator, i.e., winding I and winding II. More specifically, the outer stator teeth 108 are wound by winding I (106), while the inner stator teeth 112 are wound by winding II (110). The outer rotor 116 comprises permanent magnets (PMs) 120 and steel segments 122. The plurality of permanent magnets 120 are circumferentially magnetized. The polarity of the PMs 120 alternates around the rotor. In particular, these PMs are circumferentially magnetized with alternatively opposite polarity, between which steel segments 122 are sandwiched and retained between opposed magnets. The inner rotor 114 is a salient rotor with the features of simple structure and mechanical robustness, which is identical to those of conventional switched reluctance motors. The main parameters of the integrated flux-modulated machine 100 are listed in Table I as an example only.

TABLE I

| Parameter | Value |
|---|---|
| Number of slots for winding I | 6 |
| Number of slots for winding II | 18 |
| Number of pole-pairs of winding I | 2 |
| Number of pole-pairs of winding II | 3 |
| Number of PM pole-pairs in outer rotor | 15 |
| Number of steel segments in outer rotor | 30 |
| Number of salient poles in inner rotor | 13 |

As shown in FIG. 3, the present invention relates to an apparatus 100 comprising:
a stator 118 comprising an outer stator that comprises outer stator teeth 108 having at least one first winding 106 arranged thereon, and an inner stator that comprises inner stator teeth 112 having at least one second winding 110 arranged thereon; and
a rotor comprising an outer rotor 116 that comprises a plurality of permanent magnets 120 alternating with a plurality of steel segments 122, and an inner rotor 114 about which the outer rotor 116 is arranged.

To illustrate the operating principle, the integrated flux-modulated machine comprises two parts—the magnetic-geared PM machine part 102 and Vernier PM machine part 104. More specifically, winding I (106) on the outer stator teeth 108, PMs 120 in the outer rotor 116, and the inner rotor 114 constitute a magnetic-geared machine 102, while winding II 110 on the inner stator teeth 112, the inner stator teeth 112, and the outer rotor 116 constitute a Vernier machine 104.

For the magnetic-geared PM machine part 102, the salient poles of the inner rotor 114 work as the flux modulator. In some embodiments, salient poles of the inner rotor 114 provide the flux modulation functionality of the magnetic-geared machine component 102. In some embodiments, the magnetic-geared machine component 102 comprises the at least one first winding 106, the plurality of permanent magnets 120 of the outer rotor 116, and the inner rotor 114; and the Vernier machine component 104 comprises the at least one second winding 110, the inner stator teeth 112, and the outer rotor 116.

Based on the basic principle of the flux-modulation theory, the relationship of the pole-pair number of winding I (106), P_{WI}, PMs 120 in the outer rotor 116, Pₒᵣ, and the inner rotor 114, Pᵢᵣ, is governed by:

$${P}_{WI} = {P}_{or} - {P}_{ir} \qquad ( 1 )$$

It should be noted that the pole-pair number of the inner rotor 114 is identical to the number of the inner rotor teeth. The relationship of the frequency of winding I, f_{WI}, the outer rotor speed, nₒᵣ, and the inner rotor speed, nᵢᵣ, follows:

$${n}_{WI} {P}_{WI} = {n}_{or} {P}_{or} - {n}_{ir} {P}_{ir} \qquad ( 2 )$$

$${f}_{WI} = \frac{{n}_{WI} {P}_{WI}}{60} = \frac{( {n}_{or} {P}_{or} - {n}_{ir} {P}_{ir} )}{60} \qquad ( 3 )$$

where n_{WI} is the equivalent rotating speed of the magnetic field that winding I links. As can be seen from eqs. (2) and (3), when the two rotors 114, 116 are rotating in a “contra-rotating” manner, the induced frequency in winding I (106) would be increased, which is desirable for low-speed direct-drive wind power generation systems. Based on the law of energy conservation, one can write the torque relationship as follows:

$${n}_{WI} {T}_{st} wI + {n}_{or} {T}_{or \_ WI} + {n}_{ir} {T}_{ir \_ WI} = 0 \qquad ( 4 )$$

where T_{st_WI}, T_{or_WI}, and T_{ir_WI} are the torques generated from winding I (106) on the stator 118, the outer rotor 116, and the inner rotor 114, respectively. Based on the basic principle of magnetic gear the torque transmitted from the stator 118 to the outer rotor 116 to the inner rotor 114 is governed by:

$$\begin{matrix}{T}_{or \_ WI} = - ( \frac{{P}_{or}}{{P}_{WI}} ) \cdot {T}_{st \_ WI} \\ {T}_{ir \_ WI} = - ( \frac{{P}_{ir}}{{P}_{or}} ) \cdot {T}_{or \_ WI} = ( \frac{{P}_{ir}}{{P}_{WI}} ) \cdot {T}_{st \_ WI}\end{matrix} \} \qquad ( 5 )$$

Hence, the gear ratios between the outer rotor 116 and the stator 118, G_{or_WI}, the inner rotor 114 and the outer rotor 116, G_{ir_or}, as well as the inner rotor 114 and the stator 118, G_{ir_WI}, are as follows:

$$\begin{matrix}{G}_{or \_ WI} = - \frac{{P}_{o r}}{{P}_{WI}} ; & {G}_{irr \_ or} = - \frac{{P}_{ir}}{{P}_{or}} ; & {G}_{ir \_ WI} = \frac{{P}_{i r}}{{P}_{WI}}\end{matrix} \qquad ( 6 )$$

For the Vernier PM machine part 104, the inner stator teeth 112 work as the flux modulator. In other words, the inner stator teeth 112 provide the flux modulation functionality of the Vernier machine component 104. It should be noted that this flux modulator is a static modulator and the inner stator slots are designed as open slots in order to improve the flux-modulation effect. The relationship of the pole-pair number of winding II (110), P_{WII}, the inner stator slot number, Qᵢₙ, and the pole-pair number of PMs 120 in the outer rotor 116, Pₒᵣ, is governed by:

$${P}_{WII} = {Q}_{in} - {P}_{o r} \qquad ( 7 )$$

The relationship of the frequency of winding II (110), f_{WI}, and the outer rotor speed, nₒᵣ, follows:

$${n}_{WII} {P}_{WII} = {n}_{o r} {P}_{o r} \qquad ( 8 )$$

$${f}_{WII} = \frac{{n}_{WII} {P}_{WI}}{60} = \frac{{n}_{o r} {P}_{o r}}{60} \qquad ( 9 )$$

It should be noted that for the Vernier machine part 104, there is no torque transmission to the inner rotor 114 since the inner rotor 114 is not involved in the energy transmission as demonstrated in eq. (7). Based on the law of energy conservation, one can write the torque relationship as follows:

$${n}_{WII} {T}_{st \_ WII} + {n}_{o r} {T}_{or \_ WII} = 0 \qquad ( 10 )$$

where Tₛₜ WII and Tₒᵣ WII are the torques generated from winding II (110) on the stator 118 and the outer rotor 116, respectively. Substituting eq. (8) into eq. (10), the torque transmitted from the stator 118 to the outer rotor 116 is governed by:

$${T}_{or \_ WII} = - ( \frac{{P}_{o r}}{{P}_{WII}} ) \cdot {T}_{st SII} \qquad ( 11 )$$

Hence, the gear ratio between the outer rotor 116 and the stator 118, Gₒᵣ WII, is as follows:

$${G}_{or \_ WII} = - \frac{{P}_{o r}}{{P}_{WII}} \qquad ( 12 )$$

For the integrated flux-modulated machine including both the magnetic-geared PM machine part 102 and the Vernier PM machine part 104, the torque relationship is as follows:

$${T}_{st \_ total} = {T}_{st \_ WI} + {T}_{st \_ WII} \qquad ( 13 a )$$

$$\begin{matrix}{T}_{or \_ total} = {T}_{or \_ WI} + {T}_{or \_ WII} \\ = - ( \frac{{P}_{o r}}{{P}_{WI}} ) \cdot {T}_{st \_ WI} + [ - ( \frac{{P}_{o r}}{{P}_{WII}} ) \cdot {T}_{st \_ WI} ] \\ = {G}_{or \_ WI} {T}_{st \_ WI} + {G}_{or \_ WII} {T}_{{st}_{WII}}\end{matrix} \qquad ( 13 b )$$

$$\begin{matrix}{T}_{ir \_ total} = {T}_{ir \_ WI} \\ = - ( \frac{{P}_{i r}}{{P}_{o r}} ) \cdot {T}_{or \_ WI} = ( \frac{{P}_{i r}}{{P}_{WI}} ) \cdot {T}_{st \_ WI} \\ = {G}_{ir \_ or} {T}_{or \_ WI} = {G}_{ir \_ WI} {T}_{st \_ WI}\end{matrix} \qquad ( 13 c )$$

where T_{st_total}, T_{or_total}, and Tᵢᵣ_{_{_otal}} are the total torques generated from both winding I (106) and winding II (110) on the stator 118, the outer rotor 116, and the inner rotor 114, respectively. As can be seen from eq. (19b), the total outer rotor torque, T_{or total}, includes two components, i.e., the torque generated from the magnetic-geared machine part 102, TₒᵣWI, and the torque generated from the Vernier machine part 104, Tₒᵣ-WI. It is interesting to note that compared to the two components (T_{st_WI} and T_{st_WII}) of the total torque on the stator 118 (see eq. (19a)), the two components (T_{or_WI} and T_{or_WII}) of the total torque on the outer rotor 116 are increased by the corresponding gear ratios, i.e., G_{or_WI} and G_{or_WII}, respectively. By contrast, the total inner rotor torque, T_{ir_total}, has only one single component, i.e., the torque generated from the magnetic-geared machine part 102, Tᵢᵣ⁻ increased by the gear ratio, i.e., G_{ir_WI}, compared to the corresponding torque component on the stator 118, i.e., T_{st_WI}.

In comparison to the conventional electric machines in which the electromagnetic torque generated on the rotor is always equal to that on the stator, the presented flux-modulated machine works in a different manner, viz. both the magnetic-geared machine part 102 and the Vernier machine part 104 of this integrated machine 100 work as a conventional electric machine with a “virtual reduction gear”. This produces the “dual flux-modulation” phenomenon. More specifically, compared to the torque components generated on the stator 118, all torque components on the rotors 114, 116 are boosted by the dual “flux-modulation” effects. Hence, this machine 100 is expected to exhibit high torque density, which is desirable for direct-drive wind power generation.

In general, the present invention relates to a flux modulation apparatus. FIG. 3 shows an example flux modulation apparatus comprising: a stator 118 comprising outer stator teeth 108 having at least one first winding 106 arranged thereon and inner stator teeth 112 comprises at least one second winding arranged 110 thereon;
an outer rotor 116 comprising a plurality of permanent magnets 120 alternating with a plurality of steel segments 122; and
an inner rotor 114 about which the outer rotor 116 is arranged,
wherein the at least one first winding 106, the plurality of permanent magnets 120 and the inner rotor form a magnetic-geared machine component 102, and the at least one second winding 110, the inner stator teeth 112 and the outer rotor 116 form a Vernier machine 104, and wherein each of the magnetic-geared machine component 102 and the Vernier machine component 104 have flux modulation functionality.

The integrated machine 100 employs a decoupled design. The at least one first winding 106, of which there may be one or multiple windings as desired, is decoupled from the at least one second winding 110, of which there may also be one or multiple windings as desired. Decoupling the two sets of windings is of paramount importance, since a part of the magnetic path of winding I (106) is shared with that of winding II (110). Otherwise, additional voltages and circulating-current may be induced. This leads to control complexity and potentially affects the performance of the whole system. Direct coupling between the two sets of stator windings means that the same stator magnetomotive force (MMF) harmonic component could be produced by both sets of windings. Through such a MMF harmonic component, the two sets of windings could be coupled with each other. More specifically, when one set of windings is excited, an additional back-electromotive force (EMF) would be induced in the other set of windings. Such coupling could be avoided by appropriately selecting the slot-pole combination as described below.

The flux linkage that links winding II (110) due to the flux density produced by winding I (106), Ψ_{WII_WI}, can be expressed as follows:

$${Ψ}_{WII \_ WI} = {l}_{s k} {R}_{g} {\int }_{0}^{2 π} {N}_{WII} ( θ ) {B}_{WI} ( θ ) d θ \qquad ( 14 )$$

where lₛₖ is the stack length, R_{g} is the air-gap radius, θ is the angular position. B_{WI}(θ) is the resultant magnetic flux density distribution when winding I (106) is excited without PM excitations, which can be expressed as follows:

$${B}_{WI} ( θ ) = {\sum }_{i = 1 , 2 , 3 …} {B}_{WI} - cos ( i {P}_{WI} θ - i {ω}_{WI} t ) \qquad ( 15 )$$

N_{WII}(θ) is the winding function of winding II (110), which can be expressed as follows:

$${N}_{WII} ( θ ) = \frac{{\sum }_{j = 1 , 2 , 3 …} 2 {Q}_{i n} {k}_{u j}}{( j π {P}_{WII} )} \cdot cos ( {jP}_{WII} θ ) \qquad ( 16 )$$

where B_{W_i} is the amplitude of the i^{th} harmonic of the flux density distribution, ω_{WI} is the angular frequency of winding I (106), k_{wj} is the winding factor of the j^{th} harmonic.

As can be seen from eq. (14), the mutual flux linkage/inductance between the two sets of windings only consists of terms from the Fourier series representation of the winding function of winding II (110), N_{WII}(θ), and the magnetic flux density distribution due to winding I (106), B_{WI}(θ), which corresponds to the same absolute harmonic. More specifically, if S_{WI} and S_{WII} denote the set of absolute harmonics which have non-zero coefficients for the flux density distribution, B_{WI}(θ), and the winding function, N_{WII}(θ), respectively, then only harmonics in the intersection set, S_{WI}∩S_{WII}, contribute to the mutual flux linkage/inductance. Hence, to decouple the two sets of windings, the aforementioned intersection set should be a null/empty set, i.e., S_{WI}∩S_{WII}=∅.

It should be noted that the prerequisite for decoupling two sets of windings is that the pole-pair numbers of the two sets of windings are unequal, i.e., P_{WI}≠P_{WII}. Otherwise, the two sets of windings would always be coupled. Feasible slot-pole combinations to achieve decoupled windings are categorized into four scenarios: 1) both symmetrical windings, 2) asymmetrical winding I (106) and symmetrical winding II (110), 3) symmetrical winding I (106) and asymmetrical winding II (110), and 4) both asymmetrical windings.

Referring to the first scenario, i.e., both symmetrical windings. The condition for symmetrical windings in three-phase machines where the winding function and flux density distribution are featured with half-wave symmetry, which means no even-order harmonics, is as follows:

$$\begin{matrix}\frac{{Q}_{out}}{GCD ( {Q}_{out} , {P}_{WI} )} = 6 i , & i = 1 , 2 , 3 … \\ \frac{{Q}_{i n}}{GCD ( {Q}_{i n} , {P}_{WII} )} = 6 j , & j = 1 , 2 , 3 …\end{matrix} \} \qquad ( 17 )$$

where Qₒᵤₜ is the outer stator slot number, and GCD is the greatest common divisor.

In this both symmetrical windings scenario, there is no even-order harmonic component in the flux density distribution, B_{WN}(θ), in eq. (15), and the winding function, N_{WII}(θ), in eq. (16). Hence, the sets of absolute harmonics, S_{WI} and S_{WII}, can be expressed as follows:

$$\begin{matrix}{S}_{WI} = \{ s \vert s = {P}_{WI} ( 2 i - 1 ) , i = 1 , 2 , 3 … \} \\ {S}_{WII} = \{ s \vert s = {P}_{WI} ( 2 j - 1 ) , j = 1 , 2 , 3 … \}\end{matrix} \} \qquad ( 18 )$$

where s is the element of the set S_{WI} or S_{WII}.

Decoupling the two sets of windings could be achieved if either of the following conditions is satisfied. The first condition is that (P_{WI} is odd) & (P_{WII} is even). In particular, if P_{WI} is odd and P_{WII} is even, then S_{WI} only contains odd numbers, while S_{WI} only contains even numbers, see eq. (18). Hence, S_{WI}∩S_{WII}=∅, and the mutual flux linkage in eq. (14) will be zero. The second condition is (P_{WI} is even) & (P_{WI} is odd). The rule for the second condition can be proven in the same way as the one mentioned-above, i.e., (P_{WI} is odd) & (P_{WII} is even). The third condition is (P_{WI} and P_{WII} are both even) & (P_{WII}/P_{WI}=a/b, a and b are not both odd). It should be noted that in this condition a/b is the irreducible fraction. S_{WI}/P_{WI}={s|s=(2i−1), i=1, 2, 3 . . . }, S_{WII}/P_{WI}={s|s=P_{WII}(2j−1)/P_{WI}, j=1, 2, 3 . . . }. As S_{WI}/P_{WI} only contains odd numbers, while S_{WII}/P_{WI} doesn't contain any odd number due to the fact that a and b are not both odd, hence, S_{WI}/P_{WI}∩S_{WI}/P_{WI}=∅, and therefore, S_{WI}∩S_{WII}=∅.

Now referring to the second scenario, i.e., asymmetrical winding I (106) and symmetrical winding II (110). If winding I (106) is asymmetrical while winding II (110) is symmetrical, eq. (17) would be re-written as follows:

$$\begin{matrix}\frac{{Q}_{out}}{GCD ( {Q}_{out} , {P}_{WI} )} \neq 6 i , & i = 1 , 2 , 3 … \\ \frac{{Q}_{i n}}{GCD ( {Q}_{i n} , {P}_{WII} )} = 6 j , & j = 1 , 2 , 3 …\end{matrix} \} \qquad ( 19 )$$

In this scenario, the sets of absolute harmonics, S_{WI} and S_{WII}, in eq. (18) would be re-expressed as follows:

$$\begin{matrix}{S}_{WI} = \{ s \vert s = {P}_{WI} i , i = 1 , 2 , 3 … \} \\ {S}_{WII} = \{ s \vert s = {P}_{WII} ( 2 j - 1 ) , j = 1 , 2 , 3 … \}\end{matrix} \} \qquad ( 20 )$$

Decoupling the two sets of windings could be achieved if either of the following conditions is satisfied. The first condition is that (P_{WI} is even) & (P_{WII} is odd). In particular, if P_{WI} is even and P_{WII} is odd, then S_{WI} only contains even numbers, while S_{WII} only contains odd numbers, see eq. (20). Hence, S_{WI}∩S_{WII}=∅. The second condition is that (P_{WI} and P_{WII} are both even) & (P_{WI}/P_{WII}=a/b, a is even and b is odd). In particular, S_{WI}/P_{WII}={s|s=P_{WI}/P_{WII}, i=1, 2, 3 . . . }, S_{WII}/P_{WII}={s|s=(2j−1), j=1, 2, 3 . . . }. As S_{WI}/P_{WII} doesn't contain any odd number due to the fact that a is even and b is odd, while S_{WI}/P_{WII} only contains odd numbers, hence, S_{WI}/P_{WII}∩S_{WII}/P_{WII}=∅, and therefore, S_{WI}∩S_{WII}=∅.

Now referring to the third scenario, i.e., symmetrical winding I (106) and asymmetrical winding II (110). This scenario is similar to the previous second scenario. Hence, similar conclusion could be drawn as follows. Decoupling the two sets of windings could be achieved if either of the following conditions is satisfied: 1) (P_{WI} is odd) & (P_{WI} is even), and 2) (P_{WI} and P_{WII} are both even) & (P_{WI}/P_{WI}=a/b, a is even and b is odd).

Now referring to the fourth scenario, i.e., both asymmetrical windings. In this scenario, S_{WI}∩S_{WII}=∅, hence it is impossible to decouple the two sets of windings.

Now to consider slot-pole combination selection. Based on the theoretically analyzed results above, optional slot-pole combinations are listed in Table II, where k_{w_WI} and k_{w_WI} are the winding factors of winding I (106) and winding II (110), respectively. The numbers highlighted with green shadow represent theoretically decoupled windings, while the non-highlighted numbers represent coupled windings.

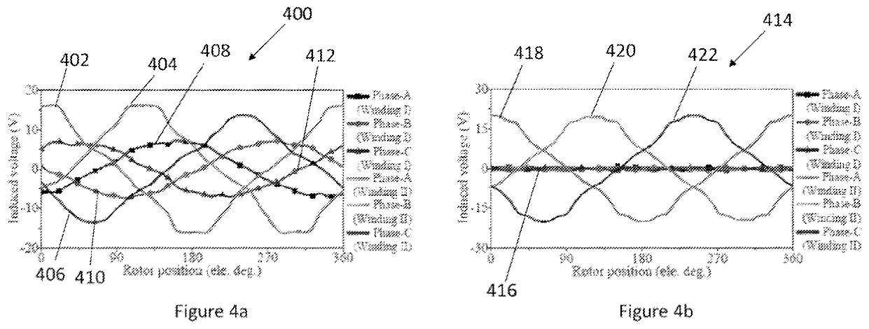

The induced voltage results of two designs including a coupled design with 6-18-2-4 (Qₒᵤₜ-Qᵢₙ-P_{WI}-P_{WII}) and a decoupled design with 6-18-2-3 in which only winding II (110) is excited, are shown in FIGS. 4a-4b. These results are obtained by finite element analysis (FEA) simulation under the operating condition of the outer rotor rotating counter-clockwise at 200 r/min and the inner rotor rotating clockwise at 300 r/min, as well as 9 A (root mean square, RMS) excitation currents in winding II (110). It should be noted that in order to eliminate the effect of PMs, PMs are removed in these FEA models. As can be seen, in the coupled design the output 400 of which is shown in FIG. 4a, significant voltages of winding I (106) are induced when only winding II (110) is excited (excitation voltages 402, 404, 406 of Phases-A, -B and -C respectively), which are referred to as “mutual-induced” voltages 408, 410 and 412 of Phases-A -B and -C respectively. By contrast, in the decoupled design the output 414 of which is shown in FIG. 4b, the induced voltages of winding I (106) are negligible when only winding II (110) is excited—induced voltages are approximately zero as shown at 416, in the presence of excitation voltages on Winding II (110) of Phases-A, -B and -C, labelled 418, 420 and 422 respectively. These results confirm the decoupling of the two windings in the decoupled design.

It should be noted that the slot-pole combinations with the number of pole-pairs of windings equal to unity are not included in Table II, since such machines exhibit the longest end-windings which will reduce the torque density. In addition, as can be seen from eq. (13), larger gear ratio of the output rotor to the associated winding is desirable to improve the output torque. Hence, the slot-pole combinations with the number of pole-pairs of windings larger than 5 which indicate small gear ratio, are also not included in Table II. Accordingly, four slot-pole combinations with decoupled windings as well as G_{or_WI} and G_{or_WII} larger than 5 are selected and investigated. They are: 1) machine I with 6-18-2-3 (Qₒᵤₜ-Qᵢₙ-P_{WI}-P_{WII}), 2) machine II with 6-30-2-5, 3) machine III with 12-24-2-4, and 4) machine IV with 12-24-4-2 . The main performance metrics of these four machines are compared and listed in Table III, where E_{WI_l} and EW_{II_l} are the fundamental component amplitudes of back-EMF of winding I (106) and winding II (110), respectively, under the condition of outer rotor rotating counter-clockwise at 200 r/min and inner rotor rotating clockwise at 300 r/min . THD is the associated total harmonic distortion, T_{avg_inner}, T_{rip_inner}, T_{avg_outer}, and T_{rip_outer} are the average torque and torque ripple of the inner rotor 114 and the outer rotor, respectively. P_{f_WI} and P_{f_WII} are the power factor of winding I (106) and winding II (110), respectively. For a fair comparison, these four machines are with the same dimension (stator outer diameter of 210 mm and stack length of 80 mm), PM volume, and electric loading.

TABLE III

| | Machine I | Machine II | Machine III | Machine IV |
|---|---|---|---|---|
| E_{WI I} (V) | 26.94 | 30.39 | 34.45 | 12.13 |
| THD of E_{WI} (%) | 3.17 | 2.57 | 2.91 | 1.96 |
| E_{WII} (V) | 32.58 | 26.36 | 28.46 | 39.59 |
| THD of E_{WII} (%) | 4.25 | 2.61 | 4.32 | 3.12 |
| T_{avg outer} (Nm) | 49.19 | 46.04 | 51.49 | 45.71 |
| T_{rip outer} (%) | 14.12 | 7.82 | 20.88 | 6.57 |
| T_{avg inner} (Nm) | −17.71 | −20.84 | −23.19 | −7.52 |
| T_{rip inner} (%) | 13.31 | 4.93 | 8.05 | 65.33 |
| P_{f WI} | 0.52 | 0.27 | 0.49 | 0.43 |
| P_{f WII} | 0.96 | 0.95 | 0.95 | 0.80 |

As can be seen, machine IV shows the lowest output torque 1 on both the inner rotor 114 and outer rotor. Machine II exhibits comparable output torque with machine I and machine III, but the power factor of winding I is the lowest. Even though machine III exhibits relatively high output torque compared to machine I, the outer rotor torque ripple of machine III is highest. Since the outer rotor is the main output shaft connected to the main turbine (see FIG. 2), high torque ripple may lead to significant noise and vibration, even potential malfunctions of the whole system. Moreover, the power factor results of both winding I and winding II of machine I are higher than those of machine III, which is preferable for wind power generation. On the other hand, the number of PMs in the outer rotor of machine I is smaller than that of machine III, i.e., 30 (machine I) vs. 40 (machine III), which is desirable for achieving high mechanical strength of the outer rotor and high manufacturing feasibility in the given size, due to the fact that punched holes are required to hold the outer rotor. Accordingly, machine I is selected for further investigation and prototyping.

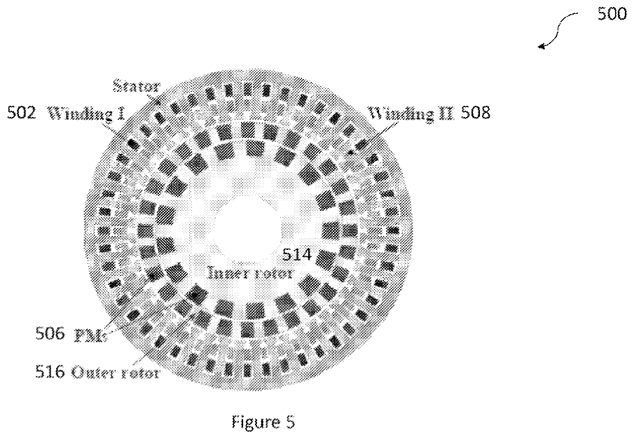

A comprehensive performance comparison is now described. To comprehensively evaluate the electromagnetic performance of the integrated flux-modulated machine, quantitative performance comparison with an existing electric machine is conducted in this section. More details about the existing machine which serves as the benchmark machine in this disclosure, as shown in FIG. 5, which shows a double-fed flux-bidirectional modulated machine 500. In the benchmark machine 500, winding I 502, steel segments, and the PMs 506 in the inner rotor 514 constitute a magnetic-geared machine, while winding II 508 and the PMs 506 in the outer rotor 516 constitute a conventional PMSM. The torque density of this machine is improved by the enhanced flux-modulation effect due to the “bidirectional flux modulation” phenomenon. More specifically, the steel segments of the outer rotor 516 work as the flux modulator to modulate the magnetic field excited by the PMs 506 in the inner rotor 514, while the salient poles of the inner rotor 514 can also work as the flux modulator to modulate the magnetic field excited by the PMs 506 in the outer rotor 516. For a fair comparison, the two machines share the same volume, slot fill factor, and electric loading. The specifications of the two machines are listed in Table IV.

TABLE IV

| | Benchmark | Presented |
|---|---|---|
| Parameter | Machine | Machine |
| Stator outer diameter (mm) | 210 | |
| Stator inner diameter (nun) | 153.4 | 140 |
| Outer air-gap length (mm) | 1.0 | |
| PM length in outer rotor (mm) | 6.1 | 15 |
| Inner air-gap length (mm) | 1.0 | |
| PM length in inner rotor (mm) | 15.8 | — |
| Inner rotor inner diameter (mm) | 46 | |
| Stack length (mm) | 80 | |
| Number of slots for winding I | 48 | 6 |
| Number of slots for winding II | 48 | 18 |
| Number of turns per phase (winding I) | 56 | |
| Number of turns per phase (winding II) | 96 | |
| Pole-pair number of winding I | 11 | 2 |
| Pole-pair number of winding II | 28 | 3 |
| Pole-pair number of PMs in outer rotor | 28 | 15 |
| Number of steel segments in outer rotor | 28 | 30 |
| Number of poles in inner rotor | 17 | 13 |

| | |
|---|---|
| Rated current of winding I (A) | 18 |
| Rated current of winding II (A) | 9 |

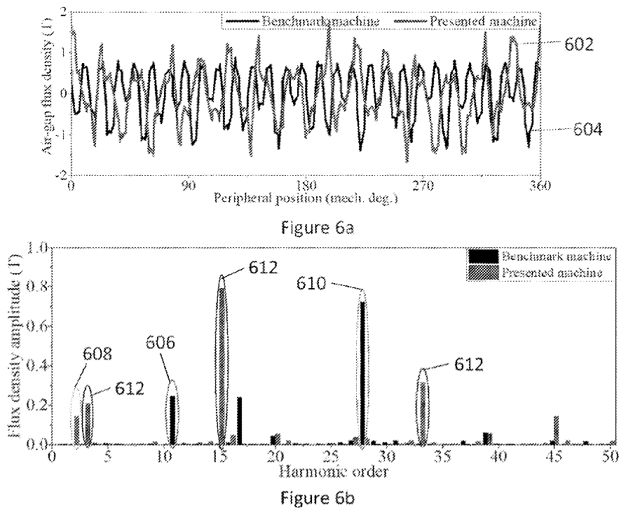

The present disclosure now discusses comparison of air-gap flux density. The no-load magnetic flux density waveforms in the outer air-gap and the associated harmonic spectra of the two investigated machines are shown in FIGS. 6a and 6b. As can be seen, for the magnetic-geared machine part of the two machines, the working harmonic amplitude of the benchmark machine (see 604) which is the 11^{th} harmonic, is higher than that of the presented machine (see 602) which is the 2^{nd} harmonic, i.e., B_{g}(11^{th})=0.25 T vs. B_{g}(2^{nd})=0.14 T. However, the equivalent flux density to produce torque, i.e., G_{or_WI}×B_{g}, of the benchmark machine is: (28/11)×0.25 T=0.64 T, which is lower than that of the presented machine, i.e., (15/2)×0.14 T=1.05 T. For the PMSM part of the benchmark machine, there is only one working harmonic, i.e., the 28^{th} harmonic=0.72 T. By contrast, for the Vernier part of the presented machine, there are three main working harmonics, i.e., the 3^{rd} harmonic B_{g}(3^{rd})=0.21 T, the 15^{th} harmonic B_{g}(15^{th})=0.79 T, and the 33^{rd} harmonic B_{g}(33^{rd})=0.31 T. The equivalent flux density of the presented machine is G_{or_WII}×B_{g}(3^{rd})+B_{g}(15^{th})−Pₒᵣ/(Pₒᵣ+Qᵢₙ)×B_{g}(33^{rd})=(15/3)×0.21+0.79−(15/33)×0.31=1.70 T, which is much higher than that of the PMSM part of the benchmark machine. Hence, the presented machine is expected to exhibit higher back-EMF and output torque than those of the benchmark machine.

FIG. 6b shows the flux density amplitude against the harmonic order of the working harmonics for the benchmark machine and presented machine. In particular, the working harmonic for the magnetically-geared machine (MGM) part of the presented machine (608) is of lower order than that of the MGM part of the benchmark machine (606). The working harmonic of the PMSM part of the benchmark machine (610) and the multiple working harmonics of the Vernier part of the presented machine (612) are also shown.

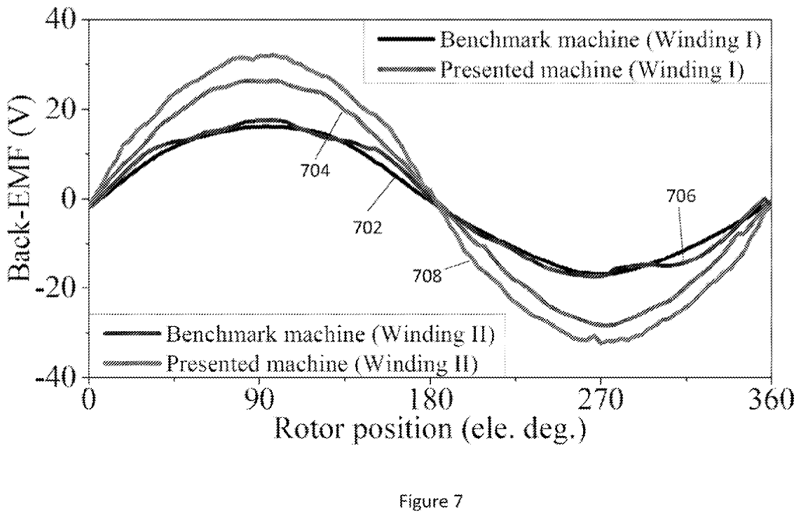

The present disclosure now discusses comparison of back-EMF. The no-load back-EMF waveforms of the two machines under the rated condition of the outer rotor rotating counter-clockwise at 200 r/min and the inner rotor rotating clockwise at 300 r/min, are shown in FIG. 7. The detailed results including the fundamental component amplitudes, E_{WI_l} and E_{WII_l}l, for winding I and winding II, respectively, as well as the total harmonic distortion, THD, are listed in Table V. As can be seen, compared to the benchmark machine (see 702), with the same number of turns per phase, the back-EMF fundamental component of winding I of the presented machine (see 704) is significantly improved from 13.62 V to 26.94 V, while the THD is reduced from 5.08% down to 3.17%. The back-EMF fundamental component of winding II of the presented machine is also improved from 17.46 V (see 706) to 32.58 V (see 708), while the THD is reduced from 7.81% down to 4.25%.

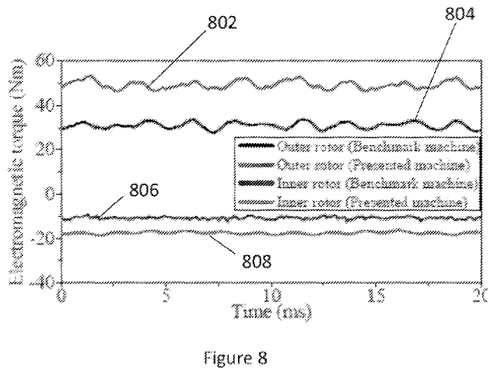

With reference to torque characteristics, the torque profiles of the two machines under the rated operating condition of 18 A (RMS) and 9 A (RMS) excitation currents in winding I and winding II, respectively, are shown in FIG. 8. As can be seen, the average torque on the outer rotor, T_{avg_outer}, of the presented machine (see 802) is significantly improved compared to the benchmark machine (see 804), i.e., 49.19 Nm vs. 30.95 Nm (˜58.93% increase), while the associated torque ripple, T_{rip_outer}, of presented machine is lower than that of the benchmark machine, i.e., 14.12% vs. 19.87%. In addition, the average torque on the inner rotor 114, T_{avg_inner}, of the presented machine (see 808) is also much higher than that of the benchmark machine (see 806), i.e., 17.71 Nm VS. 10.88 Nm (62.78% increase), while the associated torque ripple, T_{rip inner}, comparison is 13.31% (presented machine) vs. 31.50% (benchmark machine).

More detailed results are listed in Table V, which shows performance comparison of the two electric machines. As can be seen, in the case with only winding I excited, which is the magnetic-geared machine part for both the benchmark machine and the presented machine, both the outer rotor and inner rotor average torque values of the presented machine are higher than those of the benchmark machine, i.e., 20.56 Nm vs. 15.83 Nm for the outer rotor, 17.87 Nm VS. 9.98 Nm for the inner rotor 114, respectively. The ratio values of the outer rotor average torque to the inner rotor average torque of the presented machine and the benchmark machine are 20.56/17.87≈1.15 and 15.83/9.98≈1.59, which are consistent with their gear ratios between the outer rotor to the inner rotor 114, i.e., 15/13 and 28/17, respectively. The associated torque ripple results of the presented machine are lower than those of the benchmark machine, i.e., 32.45% vs. 47.25% for the outer rotor, 11.79% vs. 35.81% for the inner rotor 114, respectively. In the case with only winding II excited, the outer rotor average torque of the presented machine is also higher than that of the benchmark machine, i.e., 29.55 Nm vs. 15.43 Nm, while the torque ripple of the presented machine is lower than that of the benchmark machine, i.e., 22.54% vs. 36.11%. The inner rotor average torque results of both the two machines are almost zero, since the inner rotor 114 is not coupled with winding II for both of the two machines.

TABLE V

| | Benchmark | Presented |
|---|---|---|
| Performance | Machine | Machine |
| E_{WI I} (V) | 13.62 | 26.94 |
| THD of E_{WI}(%) | 5.08 | 3.17 |
| E [symbol] (V) | 17.46 | 32.58 |
| THD of E [symbol] (%) | 7.81 | 4.25 |
| T [symbol] (only winding I excited) (Nm) | 15.83 | 20.56 |
| T [symbol] (only winding I excited) (%) | 47.25 | 32.45 |
| T [symbol] (only winding I excited) (Nm) | −9.98 | −17.87 |
| T [symbol] (only winding I excited) (%) | 35.81 | 11.79 |
| T [symbol] (only winding II excited) (Nm) | 15.43 | 29.55 |
| T [symbol] (only winding II excited) (%) | 36.11 | 22.54 |
| T [symbol] (only winding II excited) (Nm) | −0.60 | 0.31 |
| T [symbol] (only winding II excited) (%) | — | — |
| T [symbol] (both windings excited) (Nm) | 30.95 | 49.19 |
| T [symbol] (both windings excited) (%) | 19.87 | 14.12 |
| T [symbol] (both windings excited) (Nm) | −10.88 | −17.71 |
| T [symbol] (both windings excited) (%) | 31.50 | 13.31 |
| Power factor in winding I | 0.84 | 0.52 |
| Power factor in winding II | 0.88 | 0.96 |
| Copper losses (W) | 156.01 | 156.01 |
| Core losses (W) | 39.02 | 56.22 |
| PM eddy-current losses (W) | 13.04 | 4.00 |
| Efficiency (%) | 82.63 | 88.01 |
| Output power (W) | 989.95 | 1586.49 |
| Power density (kW/L) | 0.36 | 0.59 |
| PM consumption (L) | 0.39 | 0.19 |

[symbol]

indicates data missing or illegible when filed

This disclosure now introduces other performance comparison and discussion. Besides the flux density, back-EMF, and torque characteristics mentioned-above, other performance metrics of the two machines including power factor, losses, efficiency, etc., are compared in Table V.

As can be observed, the power factor of winding I of the presented machine is lower than that of the benchmark machine, i.e., 0.52 vs. 0.84, while the power factor of winding II of the presented machine is higher than that of the benchmark machine, i.e., 0.96 vs. 0.88. The relatively low power factor of winding I of the presented machine is due to the high gear ratio between the output rotor and the associated winding in the magnetic-geared machine part. More specifically, the gear ratio between the outer rotor (output rotor) and winding I of the presented machine is G_{or_WI}=15/2, while the gear ratio between the inner rotor (output rotor) to winding I of the benchmark machine is G_{ir_WI}=17/11.

On the other hand, the efficiency of the presented machine is higher than that of the benchmark machine, i.e., 88.01% vs. 82.63%. Furthermore, compared to the benchmark machine, the power density of the presented machine is improved from 0.36 kW/L to 0.59 kW/L. Moreover, the PM usage/volume of the presented machine is significantly reduced from 0.39 L to 0.19 L, which indicates that the presented machine exhibits better PM utilization ratio.

In summary, the presented machine outperforms the benchmark machine in terms of higher back-EMF in both winding I and winding II, higher electromagnetic torque on both the outer rotor and inner rotor, higher efficiency, improved torque/power density and PM utilization ratio. The main limitation of the presented machine is the relatively low power factor of winding I, due to the high gear ratio in the magnetic-geared machine part. This issue could be overcome by reactive power compensation techniques. In some embodiments, reactive power compensation is applied by balancing the power drawn from the machine.

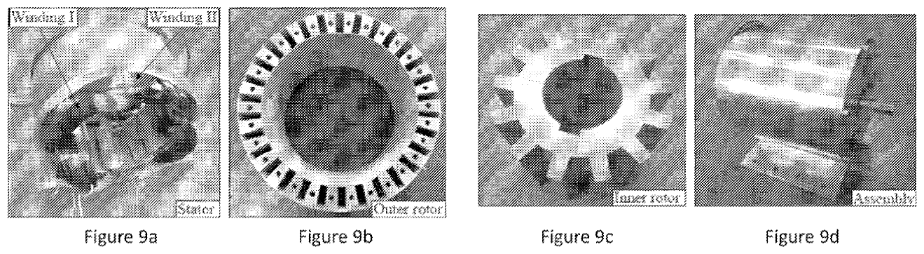

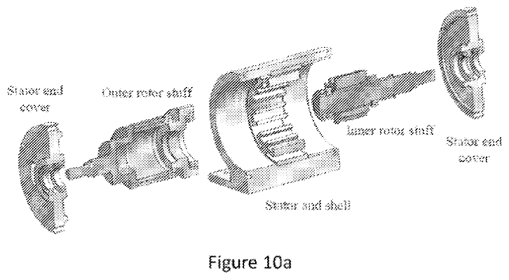

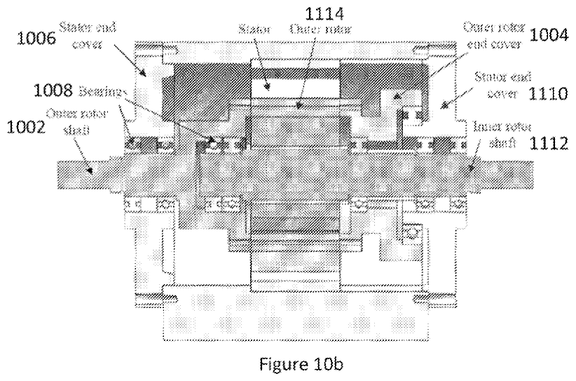

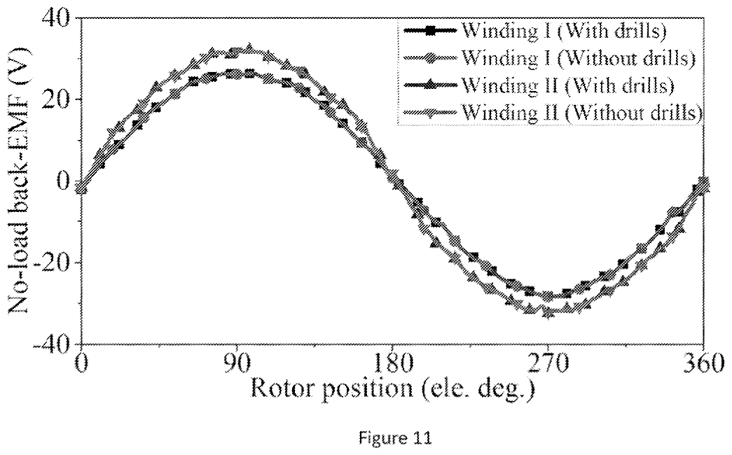

In order to verify the theoretical analysis and simulation results in of embodiments of the invention, the prototype of the integrated flux-modulated machine is fabricated and tested, as shown in FIGS. 9a-9d. For better understanding of the assembling process, the exploded and cross-sectional views of the prototype are shown in FIGS. 10a and 10b. As can be seen, the cup-shaped outer rotor comprises steel laminations and PMs. There are 30 drills with ϕ=3.8 mm in the steel laminations between each PM slot. The outer rotor 1114 is fixed by threaded rods through these drills the outer rotor shaft 1002 (left side) and the outer rotor end cover 1004 (right side). The outer rotor shaft 1002 is supported by the left stator end cover 1006 through bearings 1008 and the outer rotor end cover 1004 is supported by the right stator end cover 1110 through a bearing. By contrast, the inner rotor shaft 1112 is supported by the bearings from the outer rotor shaft 1002 on the left side, and the bearings 1008 from the stator end cover 1006 on the right side. Hence, the outer rotor 1114 and the inner rotor are decoupled from each other, and it is not necessary that they rotate at the same speed. It should be noted that the drills in the steel laminations of the outer rotor 1114 have been taken into consideration in the simulations throughout this disclosure. The no-load back-EMF waveforms of phase-A with and without drills in both winding I and winding II, under the rated condition of the outer rotor 1114 rotating counter-clockwise at 200 r/min and the inner rotor rotating clockwise at 300 r/min, are shown in FIG. 11. As can be seen, the phase-A back-EMF waveforms with and without drills are almost the same. Hence, the effect of the drills in the outer rotor 1114 on the performance metrics of the presented machine is negligible.

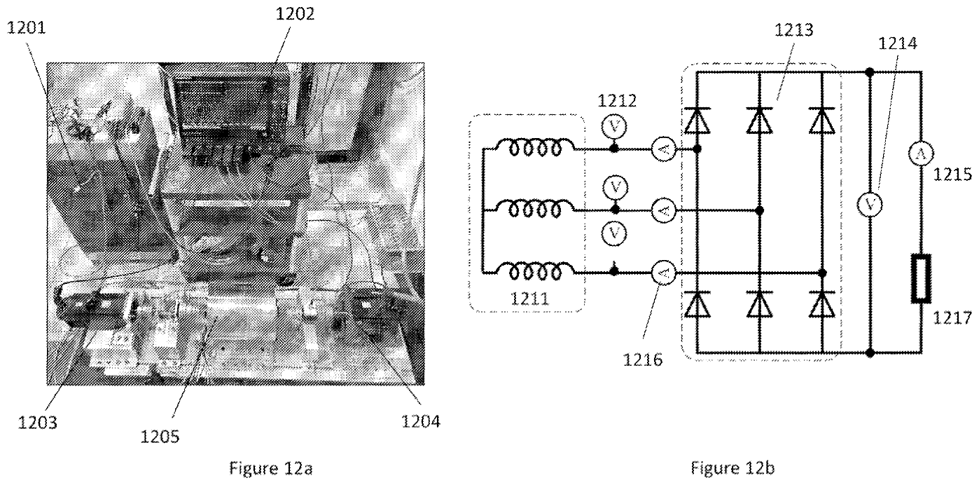

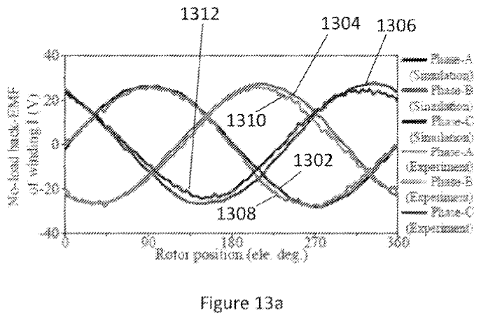

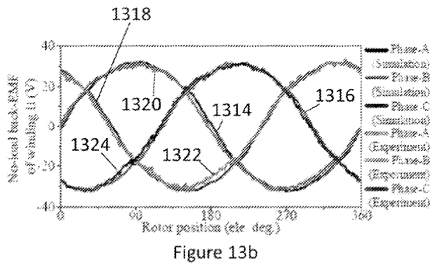

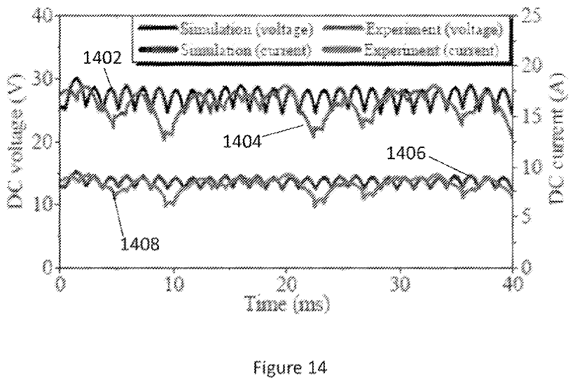

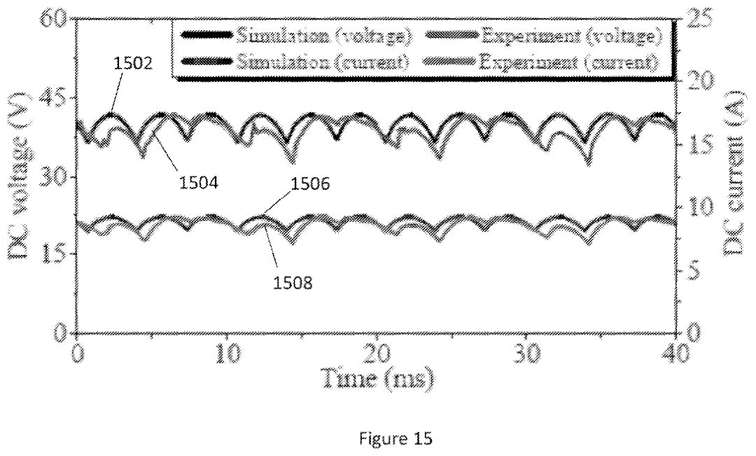

Generation performance metrics of the prototype are tested based on the hardware setup and diagram of measurement, as shown in FIGS. 12a-12b. As shown in FIG. 12a, 1201 refers to load (three-phase resistance), 1202 refers to oscilloscope, 1203 refers to the first servo motor, 1204 refers to the second servo motor, and 1205 refers to the prototype. The outer rotor and inner rotor are rotated by a serve motor, respectively. The windings of the prototype are connected to a load resistance through a three-phase uncontrolled rectifier. As shown in FIG. 12b, 1211 refers to the generator with three phases, 1212 refers to AC voltage, 1216 refers to AC current, 1213 refers to uncontrolled rectifier, 1214 refers to DC voltage, 1215 refers to DC current, and 1217 refers to load resistance. Under the rated speed of the outer rotor rotating counter-clockwise at 200 r/min and the inner rotor rotating clockwise at 300 r/min, the no-load back-EMF waveforms are shown in FIGS. 13a-13b. FIG. 13a shows simulation results 1302, 1304, 1306 of Winding I of Phases-A, -B and -C respectively, as well as experimental results 1308, 1310, 1312 of Winding I of Phases-A, -B and -C respectively). FIG. 13b shows simulation results 1314, 1316, 1318 of Winding II of Phases-A, -B and -C respectively, as well as experimental results 1320, 1322, 1324 of Winding II of Phases-A, -B and -C respectively). Under load condition, when the load resistance is set as 3.17 ohm, the results of the DC voltage (see simulation result 1402 and experimental result 1404) and current (see simulation result 1406 and experimental result 1408) generated from winding I are shown in FIG. 14. By contrast, when the load resistance is set as 4.50 ohm, the results of the DC voltage and current generated from winding II are shown in FIG. 14. The measured and simulated winding II are shown in FIG. 15, which shows the results of voltage (see simulation result 1502 and experimental result 1504) and current (see simulation result 1506 and experimental result 1508). The measured and simulated efficiency, are listed in Table VI, where Eₗ is the fundamental efficiency, are listed in Table VI, where Eₗ is the fundamental component amplitude of no-load back-EMF in phase-A, U₁ and Iₗ are the fundamental component amplitudes of phase voltage and current, respectively, U_{DC} and I_{DC} are the average DC voltage and current, respectively. As can be seen, the experimental results are in satisfactory agreement with the FEA simulated results. The relatively high discrepancy in the measured efficiency compared to the simulated result, may be due to the mechanical losses from the more bearings used in the structure (see FIG. 10(b)) and the additional losses from the rectifier.

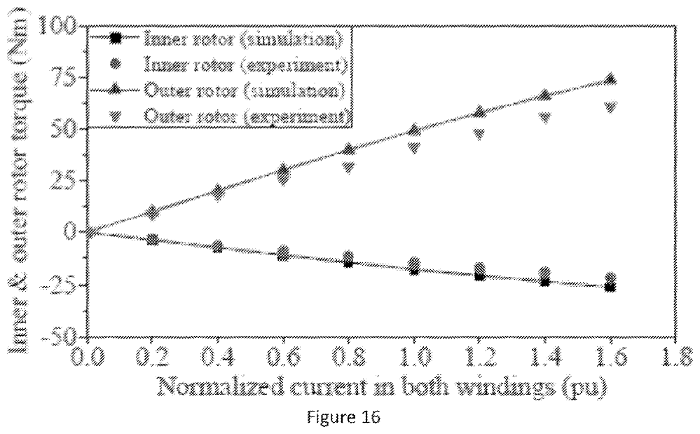

The comparison of the FEA predicted and measured inner and outer rotor average torque versus current, is shown in FIG. 16. As can be seen, the measured torque results are also in acceptable agreement with those predicted by FEA. More specifically, the discrepancy of the simulated and measured outer rotor torque under the rated condition is 16.14%, i.e., 49.19 Nm (simulated) vs. 41.25 Nm (measured), while the discrepancy of the inner rotor torque under the rated condition is 16.43%, i.e., −17.71 Nm (simulated) vs. −14.80 Nm (measured). This discrepancy may be mainly due to the mechanical losses and the end-effects of the prototype.

In general, an integrated flux-modulated machine featured taking advantage of the dual flux-modulation phenomenon for wind power generation is presented and investigated in this disclosure. As previously described, the integrated flux-modulated machine comprises two parts, i.e., magnetically-geared PM machine part 102 and Vernier PM machine part 104. The magnetically-geared machine part 102 is formed by winding I 106, PMs 120 in the outer rotor 116, and the inner rotor 114, where the salient inner rotor teeth work as the flux modulator. The Vernier machine part 104 is formed by winding II 110, the inner stator teeth 112, and the outer rotor 116, where the inner stator teeth 112 work as the flux modulator. Hence, the so-called “dual flux-modulation” phenomenon exists in this machine. Due to the “dual flux-modulation” effect, the integrated flux-modulated machine exhibits the advantage of high torque/power density, which is suitable for direct-drive contra-rotating wind power generation systems. The operating principle of the integrated flux-modulated machine is demonstrated in detail. Decoupled design of the two sets of windings is investigated, and a general rule to achieve decoupled windings by appropriate slot-pole combination selection is illustrated. The advantages of the presented machine are confirmed in comparison with a benchmark machine. Finally, the integrated flux-modulated machine is prototyped, and the experimental results verify the feasibility and validity of the operating principle and the FEA predictions of the presented machine.

A new dual-mechanical-port (DMP) electric machine for hybrid electric vehicle applications, particularly in the power-split continuously variable transmission systems, is proposed. To comprehensively and quantitatively evaluate the pros and cons of the proposed machine, a comparative study of four DMP electric machines with different topologies is conducted. These four investigated DMP electric machines include a conventional DMP machine, a machine with reluctance rotor, and a DMP machine with open slots which is the proposed machine in this invention. Even though these four machines have similar topologies, they have different operating principles, which are demonstrated in detail. The comparison results indicate that the DMP machine with open slots outperforms the others in terms of torque/power density, efficiency, magnet utilization, etc. Accordingly, the DMP machine with open slots is selected for further investigation and optimization. A large-scale multi-objective optimization is carried out for this machine, where the differential evolution algorithm serves as a global search engine to target optimal performance. Finally, an optimal design is prototyped, and the experimental results are performed to verify the effectiveness of the analysis and simulation results in this invention.

Compared to conventional internal combustion engine (ICE) vehicles, electric vehicles (EVs) and hybrid electric vehicles (HEVs) have been gaining more interest from the automotive industry and consumers, due to their superior vehicle performance, fuel economy, and reduced emissions. Due to the limitation of the current battery capacity, range anxiety is an inevitable issue for pure EVs. By contrast, HEVs have been recognized as the best compromise of conventional vehicles and pure EVs, which can offer better fuel efficiency, good driving performance, and longer distance/ranges.

The power-split continuously variable transmission (CVT) system plays a paramount/significantly important role in the success of modern HEVs, which transmits energy from input-port to output-port without conventional clutches or step ratio mechanical gears. Current commercial solutions for the CVT system in existing HEVs, e.g., Toyota Prius, are based on a planetary mechanical gear which serves as the power-splitting device to distribute the kinetic power from an ICE and a drive motor. However, the planetary mechanical gear inevitably leads to bulkiness and heaviness, additional losses and hence reduced efficiency, noise and vibration, regular maintenance requirement, and high cost.

To solve the aforementioned issues associated with mechanical gears, several dual-mechanical-port (DMP) electric machines were developed and have attracted increasing attention. Compared to conventional electric machines, DMP machines integrate the function of the planetary mechanical gear and the drive motor, which makes them more suitable for direct-drive CVT systems in HEVs due to their inherently compact structure. To further improve the torque density of DMP machines, DMP machines have advanced by using flux modulation theory. Some DMP magnetically-geared machines employ a stator with windings, a modulating pole-pieces rotor, and a PM rotor, and integrate a magnetic gear instead of a mechanical reduction gear, into a surface-mounted PM machine. Hence, these machines inherently exhibit improved torque production capability.

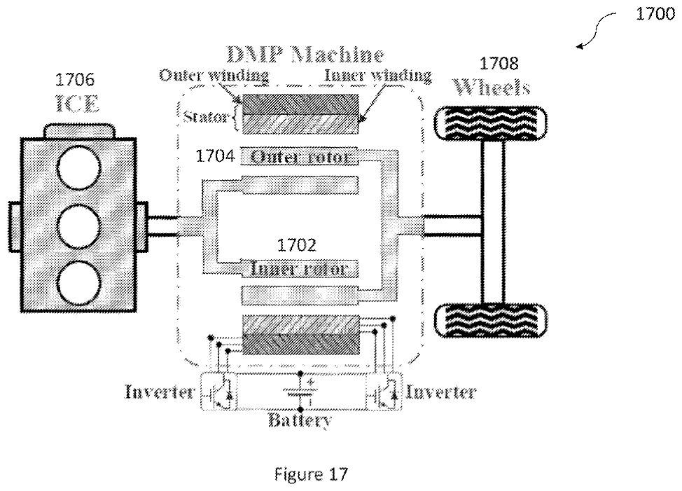

A new DMP electric machine for the CVT-based HEV applications is proposed described with reference to FIG. 17. To comprehensively and quantitatively evaluate the pros and cons of the proposed machine, a comparative study of four DMP electric machines with different topologies is conducted. These four investigated DMP electric machines include a conventional DMP machine, a DMP machine with spoke-type PMs, a DMP machine with reluctance rotor, and a DMP machine with open slots which is the proposed machine in this invention. Even though these topologies are similar, they have different operating principles. These four machines are investigated and compared in detail. The results indicate that the DMP machine with open slots outperforms the others in terms of torque/power density, efficiency, magnet utilization, etc. Accordingly, the DMP machine with open slots is selected for further investigation and optimization.

The schematic diagram of a DMP electric machine 1700 used in CVT systems of HEVs is shown in FIG. 17. As can be seen, the inner rotor 1702 and the outer rotor 1704 of the DMP machine 1700 work as the two mechanical ports, which are directly connected to the ICE 1706 and the wheels 1708, respectively. The two rotors 1702 and 1704 can rotate mechanically independent of each other so that the speed ratio between the two rotors can be varied in a continuously variable way, similar to the carrier and ring gears of the planetary gear set in conventional CVT systems. Hence, the ICE in this CVT system can always be operated at the highest efficiency speed, while the vehicle is allowed to run at any desired speeds. Through the DMP machine 1700, the power from both the ICE 1706 and the battery splits according to the actual requirements of the HEV. Embodiments of the DMP machine 1700 have two or more modes of operation - these modes include motor or power mode, and generator or storage mode. More specifically, when the power supplied from the ICE 1706 is insufficient, e.g., when the HEV is driven at startup or uphill where more power is needed, the DMP machine can work in motor or power mode to provide further support to drive the HEV. By contrast, when the power supplied from the ICE 1706 exceeds the required power, e.g., when the HEV is driven at regenerative braking, idling time, or downhill, the DMP machine 1700 can work in generator or storage mode to convert the redundant energy into electric energy which would be stored in the battery. This single DMP machine achieves the full functions of both the planetary mechanical gear and the drive motor in conventional HEV traction systems without the planetary mechanical gear set. As a result, the efficiency of the whole traction system is improved, and the inevitable issues caused by the planetary mechanical gear in conventional CVT systems are eliminated.

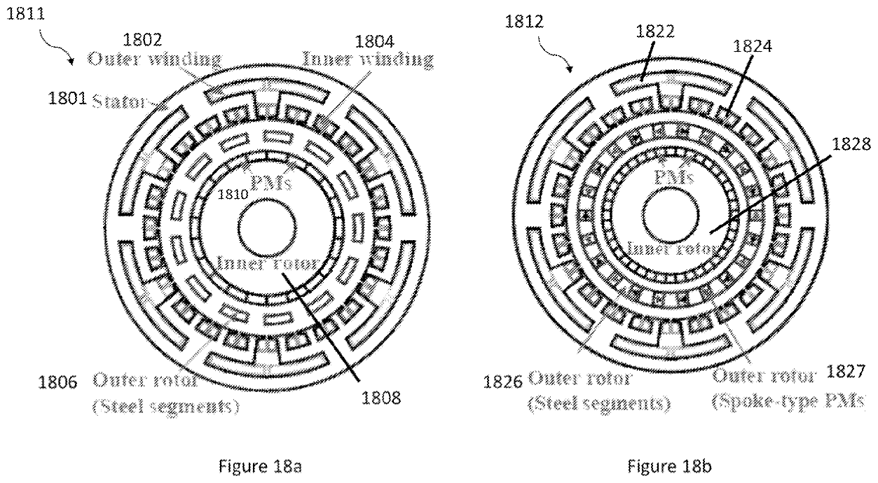

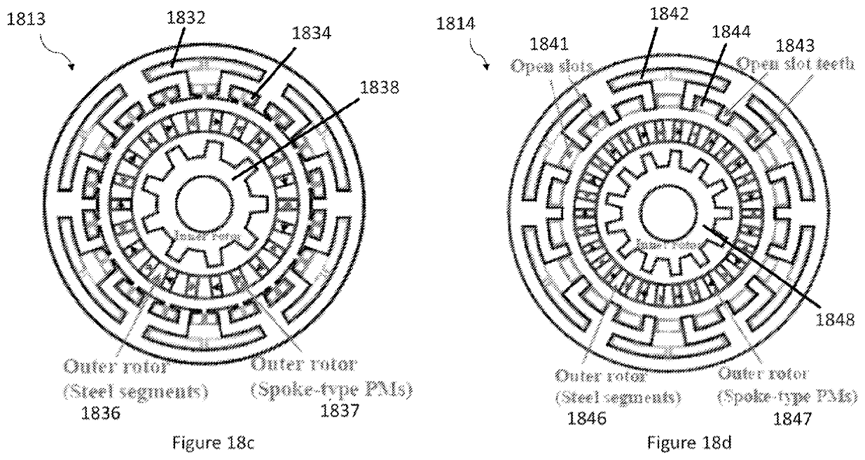

Four DMP electric machines with different topologies are compared and investigated, i.e., a conventional DMP machine (M-I), a DMP machine with spoke-type PMs (M-II), a DMP machine with reluctance rotor (M-III), and a DMP machine with open slots (M-IV), as shown in FIGS. 18a-18d respectively. It should be noted that the DMP machine with open slots is proposed herein.

For a fair comparison, the four investigated machines share the same volume (outer diameter and stack length), electric loading for both the inner and outer windings, both outer and inner air-gap thicknesses, as well as PM content. The main parameters of the four machines are listed in Table VII.

TABLE VII

| | M-I | M-II | M-III | M-IV |
|---|---|---|---|---|
| Stator oute diameter (mm) | 210 | | | |
| Stator inner diameter (mm) | 130 | | | |
| Stack length (mm) | 80 | | | |
| Slot number for outer winding | 6 | | | |
| Slot number for inner winding | 24 | 24 | 18 | 18 |
| Number of turns per phase (outer winding) | 68 | | | |
| Number of turns per phase (inner winding) | 96 | | | |
| Rated current (A) (outer winding) | 18 | | | |
| Rated current (A) (inner winding) | 9 | | | |
| Outer winding pole-pair number, P [symbol] | 2 | | | |
| Inner winding pole-pair number, P [symbol] | 11 | 11 | 11 | 3 |
| Outer rotor steel segment number | 13 | 22 | 22 | 30 |
| Outer rotor PM pole-pair number, P [symbol] | — | 11 | 11 | 15 |
| Inner rotor PM pole-pair number, P [symbol] | 11 | 20 | — | — |
| Inter rotor salient tooth number | — | — | 9 | 13 |

| | |
|---|---|
| Outer air-gap thickness (mm) | 1 |
| Inner air-gap thickness (mm) | 1 |
| PM volume (L) | 0.22 |
| PM material | N40UH (NdFeB [symbol] B [symbol] = 1.26 |
| | T [symbol] H [symbol] = 912 kA/m) |

[symbol]

indicates data missing or illegible when filed

Regarding the conventional DMP machine (M-I, see 1811), as can be seen from FIG. 18a, there are two sets of windings in the stator 1801 for the conventional DMP machine 1811, i.e., outer winding 1802 and inner winding 1804. The outer rotor 1806 consists of steel segments, while the inner rotor 1808 is a conventional surface-mounted PM rotor where the PMs 1810 are radially magnetized with alternative opposite polarity. The outer winding 1802, the steel segments of the outer rotor 1806, and the inner rotor 1808, effectively form a magnetically-geared machine (MGM) portion, where the steel segments of the outer rotor 1806 work as the flux modulator. The flux modulator plays a role in matching the two magnetic flux fields from the stator 1801 and the inner rotor 1808, which is the so-called “flux-modulation” phenomenon. Hence, the relationship of the outer winding pole-pair number, P_{ow}, the flux modulator pole number (steel segment number of the rotor, Pᵢᵣ, is governed by:

$${P}_{o w} = \vert {P}_{fw} - {P}_{i r} \vert ⇒ 2 = 13 - 11 \qquad ( 21 )$$

The inner winding 1804 and the inner rotor 1808 effectively form a regular permanent magnet synchronous machine (PMSM) portion. Hence, the relationship of the inner winding pole-pair number, P_{iw}, and the PM pole-pair number of the inner rotor 1808, Pᵢᵣ, is governed by:

$${P}_{i w} = {P}_{i r} ⇒ 11 = 11 \qquad ( 22 )$$

Regarding conventional DMP machine with spoke-type PMs (M-II, see 1812), as can be seen from FIG. 18b, differing from the conventional DMP machine 1811, the outer rotor of this machine 1812 consists of both steel segments 1826 and spoke-type PMs 1827 which are circumferentially magnetized with alternative opposite polarity. The outer winding 1822, the steel segments 1826 of the outer rotor, and the inner rotor 1828, effectively form an MGM portion, where the steel segments 1826 of the outer rotor work as the flux modulator. Hence, the relationship of the outer winding pole-pair number, P_{ow}, the flux modulator pole number (steel segment number of the outer rotor), P_{fm}, which is equal to twice the PM pole-pair number of the outer rotor, Pₒᵣ, i.e., P_{fm}=2Pₒᵣ, and the PM pole-pair number of the inner rotor 1828, Pᵢᵣ, is governed by:

$${P}_{o w} = \vert {P}_{fm} - {P}_{i r} \vert ⇒ 2 = 22 - 20 \qquad ( 23 )$$

The inner winding 1824 and the outer rotor effectively form a regular PMSM portion. Hence, the relationship of the inner winding pole-pair number, P_{iw}, and the PM pole-pair number of the outer rotor, Pₒᵣ, is governed by:

$${P}_{i w} = {P}_{o r} ⇒ 11 = 11 \qquad ( 24 )$$

Regarding DMP machine with reluctance rotor (M-III, see 1813), as can be seen from FIG. 18c, the outer rotor of the DMP machine 1813 with reluctance rotor is similar to that of the DMP machine 1812 with steel segments 1836 and spoke-type PMs 1837 (see FIG. 18b), while the inner rotor 1838 of this machine 1813 is a reluctance rotor. The outer winding 1832, the PMs 1837 of the outer rotor, and the inner reluctance rotor 1838, effectively form an MGM portion, where the inner reluctance rotor 1838 works as the flux modulator. Hence, the relationship of the outer winding pole-pair number, P_{ow}, the flux modulator pole number which is equal to the salient tooth of the outer rotor, Pₒᵣ, is governed by:

$${P}_{o w} = \vert {P}_{fm} - {P}_{o r} \vert ⇒ 2 = \vert 9 - 11 \vert \qquad ( 25 )$$

The inner winding 1834 and the outer rotor effectively form a regular PMSM portion. Hence, the relationship of the inner winding pole-pair number, P_{iw}, and the PM pole-pair number of the outer rotor, Pₒᵣ, is governed by:

$${P}_{i w} = {P}_{o r} ⇒ 11 = 11 \qquad ( 26 )$$

Regarding a DMP machine with open slots (M-IV, see 1814), as can be seen from FIG. 18d, differing from the aforementioned three DMP machines which exhibit mono/single flux-modulation phenomenon within each other, the DMP machine 1814 with open slots 1841 exhibits a “dual flux-modulation” phenomenon, which will be explained in detail in the following. The outer winding 1842, the PMs 1847 of the outer rotor, and the inner reluctance rotor 1848, effectively form an MGM portion, where the inner reluctance rotor 1848 works as the flux modulator. Hence, the relationship of the outer winding pole-pair number, P_{ow}, the flux modulator pole number which is equal to the salient tooth number of the inner rotor, P_{fm}, and the PM pole-pair number of the outer rotor, Pₒᵣ, is governed by:

$${P}_{o w} = \vert {P}_{fm} - {P}_{o r} \vert ⇒ 2 = \vert 13 - 15 \vert \qquad ( 27 )$$

It should be noted that differing from the aforementioned three DMP machines which have semi-closed slots for the inner winding (they may be separated by a partition, spacer or other device), the DMP machine 1814 with open slots 1841 in FIG. 18d has open slots for the inner winding. The inner winding 1844, the open slot teeth 1843 of the stator, and the PMs of the outer rotor, effectively form a Vernier machine portion, where the open slot teeth 1843 work as the flux modulator which is a static flux modulator and different from the rotating flux modulators mentioned-above. Hence, the relationship of the inner winding pole-pair number, P_{iw}, the static flux modulator pole number which is equal to the number of the open slot teeth for the inner winding 1844, Qᵢₙ, and the PM pole-pair number of the outer rotor, Pₒᵣ, is governed by:

$${P}_{i w} = \vert {Q}_{i n} - {P}_{o r} \vert ⇒ 3 = 18 - 15 \qquad ( 28 )$$

Hence, flux modulation phenomenon takes place in both the MGM portion and the Vernier machine portion of the proposed DMP machine with open slots 1814. This is the so-called “dual flux-modulation” phenomenon.

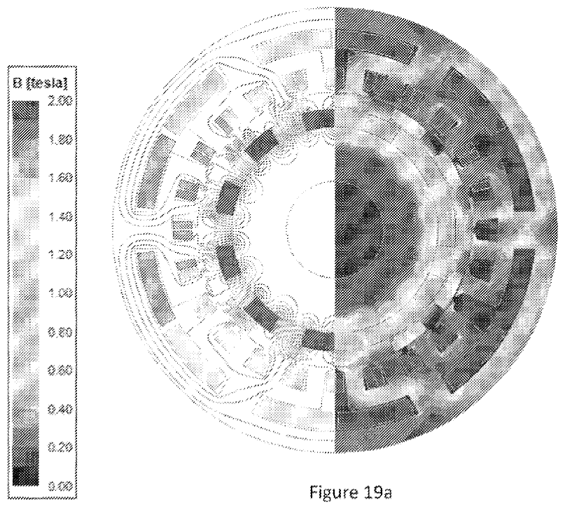

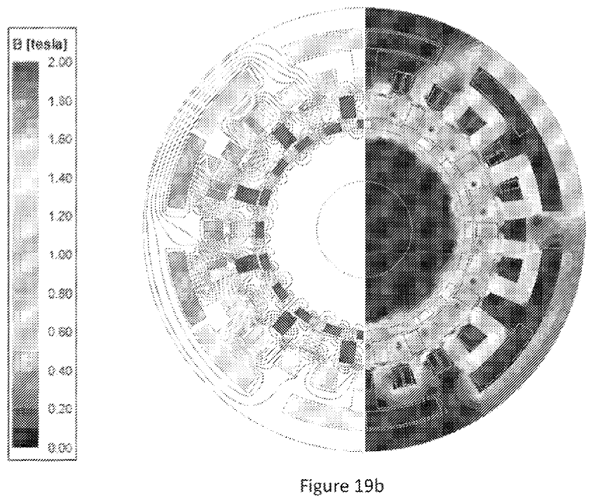

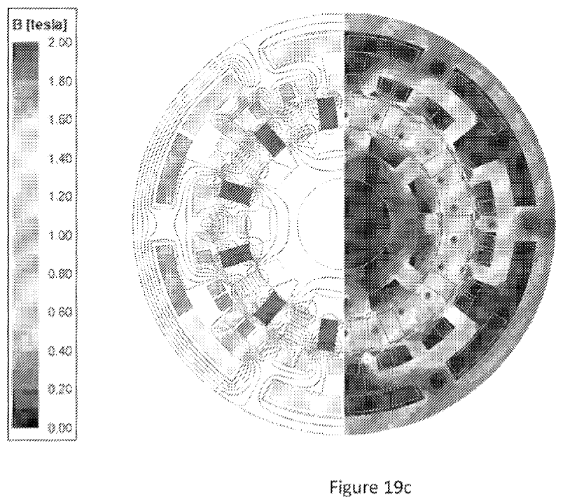

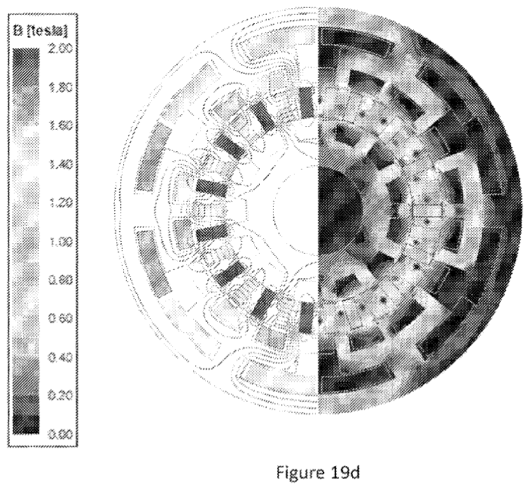

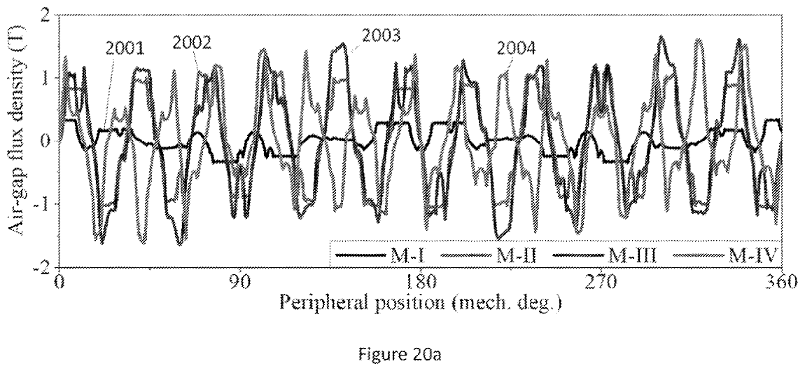

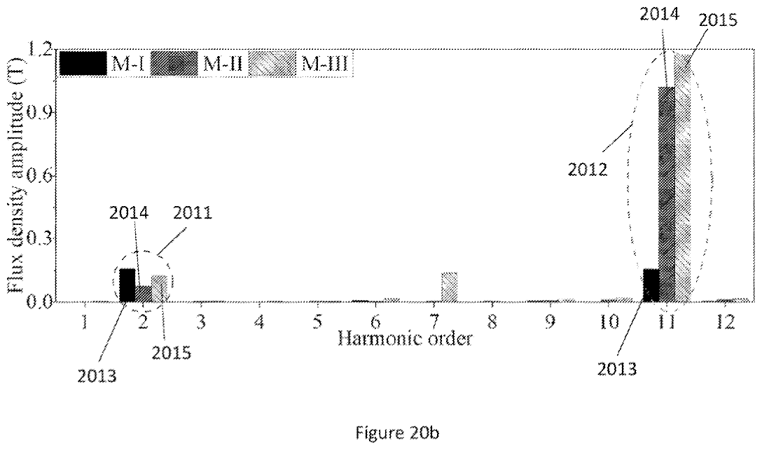

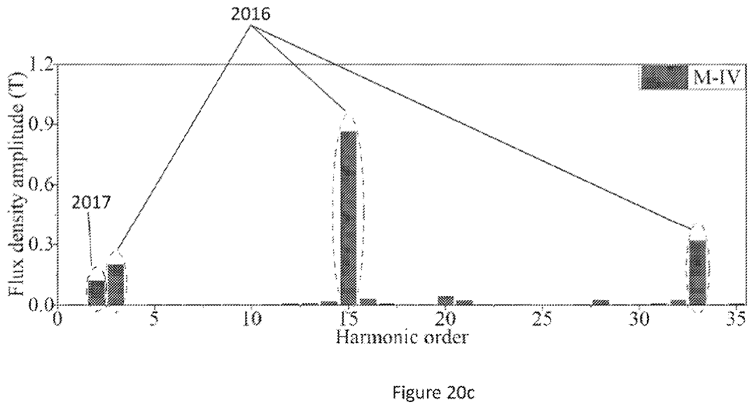

The flux lines and flux density distribution of the four investigated machines 1811, 1812, 1813, 1814 under no-load condition are shown in FIGS. 19a-19d respectively. The flux density profiles at the center of the air-gap and the corresponding harmonic spectra are shown in FIGS. 20a to 20c. FIG. 20a shows air-gap flux density results 2001, 2002, 2003, 2004 for M-I 1811, M-II 1812, M-III 1813, and M-IV 1814, respectively. FIG. 20b shows flux density amplitude against harmonic order for M-I (see 2013), M-II (see 2014), and M-III (see 2015), respectively. In particular, FIG. 20b shows the results of working harmonic for MGM portion (see 2011), and the results of working harmonic for Vernier machine portion (see 2012). FIG. 20c shows flux density amplitude results for M-IV. In particular, FIG. 20c shows the results of working harmonic for Vernier machine portion (see 2016), and the results of working harmonic for MGM portion (see 2017). For better understanding of the operating principles of the four investigated machines, the following definitions are introduced:

For the PMSM portion, the output torque, T_{e_PMSM}, can be expressed as follows:

$${T}_{e\_PMSM} = ( \frac{3}{2} ) p {k}_{w} {N}_{p h} S {i}_{q} {B}_{g} \qquad ( 29 )$$

where p is the number of pole-pairs, k_{w} is the winding factor, Nₚₕ is the number of series turns per phase, S is the cross-sectional area of each pole, i_{q} is the q-axis current, B_{g} is the amplitude of the fundamental air-gap flux density.

For the MGM portion, since the MGM can be regarded as a PMSM and a virtual gear with the gear ratio of Gᵣ, the output torque, T_{e_MGM}, can be expressed as follows:

$${T}_{e\_MGM} = {T}_{e\_PMSM} \cdot {G}_{r} = ( \frac{3}{2} ) p {k}_{w} {N}_{p h} S {i}_{q} {B}_{g} {G}_{r} \qquad ( 30 )$$

For the Vernier machine portion, the output torque, T_{e_VM}, can be expressed as follows:

$${T}_{e\_VM} = ( \frac{3}{2} ) p {k}_{w} {N}_{p h} S {i}_{q} \cdot [ {B}_{g} + ( \frac{{P}_{o r}}{{P}_{i w}} ) \cdot {B}_{{g\_P}_{w r}} - \frac{{P}_{o r}}{( {Q}_{i n} + {P}_{o r} )} \cdot {B}_{{g\_Q}_{i n} + {P}_{o w}} ] \qquad ( 31 )$$

where B_{g_P}_{_{mw}} and B_{g_Q}_{_{w+}}_{+P}_{_{w}} are the amplitudes of the flux density of the harmonic order of P_{iw} and (Qᵢₙ+Pₒᵣ), respectively.

Accordingly, the “effective flux density” can be defined as 1) for the PMSM portion is B_{g}, 2) for the MGM portion is B_{g}Gᵣ and 3) for the Vernier machine portion is [B_{g}+Pₒᵣ/P_{iw}·B_{g_P}_{ₒᵤ}_{-P}_{ₒᵣ}/(Qᵢₙ+Pₒᵣ)·B_{g_Q}_{ᵢₙ}_{+P}_{ₒᵣ}]. The flux density characteristics of the four investigated machines are listed in Table VIII. As can be seen, the proposed DMP machine with open slots (M-IV 1814) exhibits the highest effective flux density for the MGM portion and the Vernier machine portion. This is due to the fact that for the MGM portion, the proposed DMP machine with open slots (M-IV 1814) exhibits relatively high gear ratio and high amplitude of the working harmonic which is the 2^{nd} harmonic component; for the PMSM/Vernier portion of the Vernier portion of the proposed DMP machine with open slots (M-IV 1814), while there is one single working harmonic for the counterpart PMSM portion of the other three candidates. As a result, the proposed DMP machine with open slots (M-IV 1814) is expected to exhibit higher output torque/power capability.

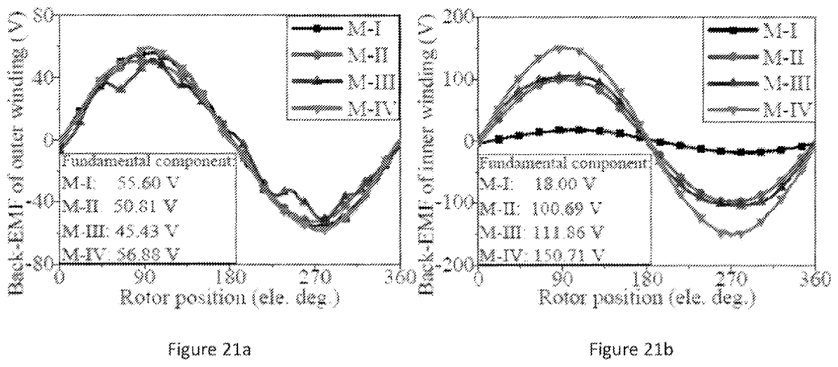

The no-load back-electromotive force (EMF) profiles of the four machines under the condition that the rotor of the PMSM/Vernier machine portion (which is the inner rotor for M-I 1811, while the outer rotor for M-II 1812, M-III 1813, and M-IV 1814) is rotating at the speed of 1000 r/min, while the other rotor is at standstill, are shown in FIGS. 21a and 21b. The fundamental component amplitudes of the outer winding, Eₗ_{_{_out}}, are 55.60 V, 50.81 V, 45.43 V, and 56.88 V for M-I 1811, M-II 1812, M-III 1813, and M-IV 1814, respectively. The fundamental component amplitudes of the inner winding, E_{l_in}, are 18.00 V, 100.69 V, 111.86 V, and 150.71 V for M-I 1811, M-II 1812, M-III 1813, and M-IV 1814, respectively. As can be seen, M-IV 1814 exhibits the highest back-EMF fundamental components of both the outer winding and the inner winding.

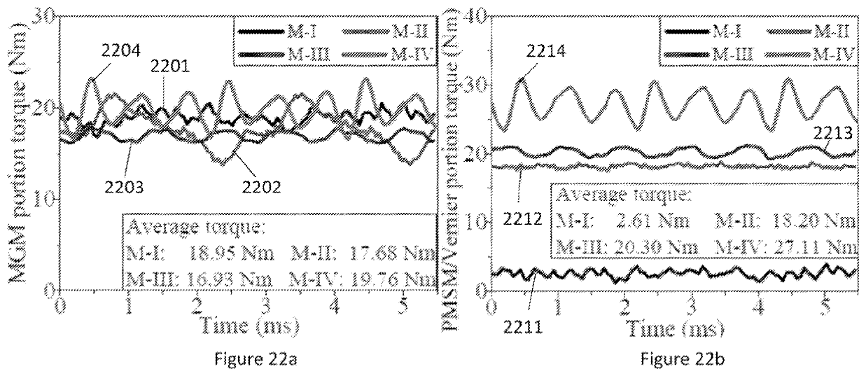

The MGM portion torque profiles of the four machines (see profile 2201 for M-I 1811, profile 2202 for M-II 1812, profile 2203 for M-III 1813, profile 2204 for M-IV 1814) with only outer winding excitation are shown in FIG. 22a. As can be seen, the average output torque results are 18.95 Nm, 17.68 Nm, 16.93 Nm, and 19.76 Nm for M-I 1811, M-II 1812, M-III 1813, and M-IV 1814, respectively. The PMSM/Vernier portion torque profiles (see profile 2211 for M-I 1811, profile 2212 for M-II 1812, profile 2213 for M-III 1813, profile 2214 for M-IV 1814) with only inner winding excitation are shown in FIG. 22b. As can be seen, the average output torque results are 2.61 Nm, 18.20 Nm, 20.30 Nm, and 27.11 Nm for M-I 1811, M-II 1812, M-III 1813, and M-IV 1814, respectively. As can be observed, M-IV 1814 exhibits the highest average output torque for both the MGM portion and the PMSM/Vernier portion.

The key performance metrics of the four investigated machines are compared and listed in Table IX, where T_{avg_r} and T_{avg_s} are the average torques with both the outer and inner winding excitations of the rotating rotor (inner rotor for M-I 1811, outer rotor for M-II 1812, M-III 1813, and M-IV 1814) and the standstill rotor, respectively, while T_{rip_r} and T_{rip_r} are the corresponding torque ripples. Pf_{_out} and P_{f_in} are the power factor of the outer winding and the inner winding, respectively.

As can be seen from the aforementioned results, even though the MGM portion outputs of M-I 1811 including the back-EMF and the output torque is relatively high (higher than 1 those of M-II 1812 and M-III 1813, see FIGS. 21a and 21b), the PMSM portion outputs of M-I 1811 are very low (see FIGS. 21b and 22b. This is due to the fact that for the PMSM portion of M-I 1811, the PMs are too far away from the stator (see FIGS. 18a and 19a). Hence, the equivalent air-gap thickness is very large, and the magnetic reluctance is very high.

Compared to M-I 1811, the PMSM portion outputs of M-II 1812 are significantly improved (see FIGS. 21b and 22b). This is due to the fact that by inserting the spoke-type PMs into the outer rotor, the magnetic reluctance of the PMSM portion is significantly reduced. Moreover, the spoke-type PMs exhibit flux-focusing effects, which further improves the PMSM portion outputs. The MGM portion outputs of M-II 1812 are slightly lower than those of M-I 1811, even though these two machines have similar structure for the MGM portion. This is due to the fact that compared to M-I 1811, the PM excitation of M-II 1812 for the MGM portion is reduced.

The MGM portion outputs of M-III 1813 are slightly lower than those of M-II 1812 (see FIGS. 21a and 22a), due to the fact that the flux modulator of M-III 1813 is moved from the outer rotor to the inner rotor, which is farther away from the armature winding, i.e., the outer winding, and hence, the flux modulation effect is reduced. However, the power factor of the outer winding is improved (see Table IX), which may be due to the fact that the flux leakage is reduced. The PMSM portion outputs of M-III 1813 are higher than those of M-II 1812 (see FIGS. 21b and 22b) due to the increased PM excitation for the PMSM portion. Moreover, design of electric machines used for HEVs.

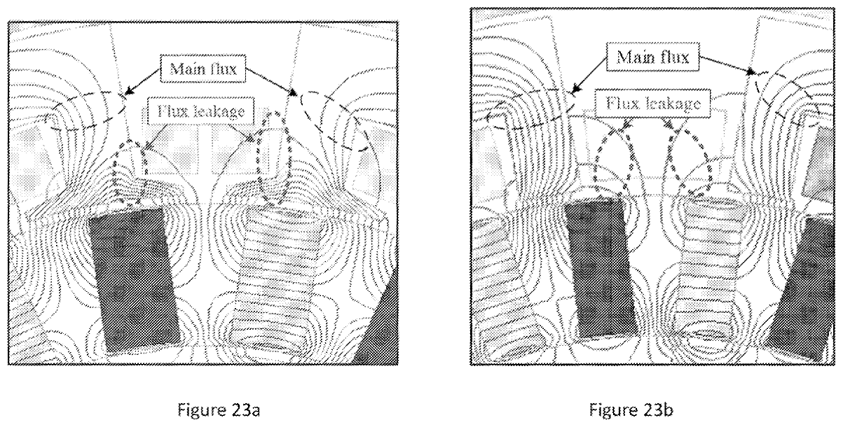

The MGM portion outputs of M-IV 1814 are higher than those of M-III 1813 (see FIGS. 21a and 22a), even though these two machines have similar structure for the MGM portion. This is due to the fact that M-IV 1814 has higher gear ratio than M-III 1813, i.e., 7.5 for M-IV 1814 vs. 5.5 for M-III 1813 (see Table VIII). Another potential reason is that compared to M-III 1813, the slot opening flux leakage of M-IV 1814 is reduced due to the open slot structure, as shown in FIGS. 23a and 23b for M-III 1813 and M-IV 1814 respectively. The PMSM/Vernier portion outputs of M-IV 1814 are significantly improved compared to the other three candidates. This is due to the fact that this portion of M-IV 1814 works in a Vernier machine manner which acts as a regular PMSM plus a virtual reduction gear, and more working harmonics are involved in energy conversion (see Table VIII), while this portion of the other three machines work as a regular PMSM.

It should be noted that Vernier PM machines typically suffer from a low power factor. Moreover, there are crucial issues for conventional Vernier PM machines using spoke-type PM structure, due to the oscillation of the rotor magnetomotive force. As a result, the output torque capability will be significantly reduced. However, the Vernier machine portion of M-IV 1814 exhibits a very high-power factor of 0.98 (see Table IX), and the output torque of the Vernier machine portion is very high.

TABLE IX

| | M-I | M-II | M-III | M-IV |
|---|---|---|---|---|
| Outer rotor speed (r/min) | 0 | 1000 | 1000 | 1000 |
| Inner rotor speed (r/min) | 1000 | 0 | 0 | 0 |
| Frequency of outer | 183.33 | 366.67 | 183.33 | 250 |
| winding (Hz) | | | | |
| Frequency of inner | 183.33 | 183.33 | 183.33 | 250 |
| winding (Hz) | | | | |
| T_{avg r} (both | 21.89 | 34.74 | 36.05 | 46.31 |
| windings) (Nm) | | | | |
| T_{rip r}(%) | 14.72% | 22.48% | 6.70% | 13.41% |
| T_{avg s} (both | −22.83 | −16.10 | −12.78 | −17.23 |
| windings) (Nm) | | | | |
| T_{rip s}(%) | 20.26% | 9.37% | 3.08% | 3.76% |
| P_{f out} | 0.40 | 0.21 | 0.49 | 0.42 |
| P_{fin} | 0.92 | 0.99 | 0.99 | 0.98 |
| Output power (kW) | 2.29 | 3.64 | 3.77 | 4.85 |
| Core losses (W) | 125.00 | 286.42 | 164.47 | 160.37 |
| Copper losses (W) | 156.01 | 156.01 | 156.01 | 156.01 |
| PM eddy-current | 35.68 | 51.19 | 18.39 | 40.55 |
| losses (W) | | | | |
| Efficiency | 87.86% | 88.05% | 91.76% | 93.14% |
| Torque density (Nm/L) | 16.14 | 18.35 | 17.63 | 22.94 |
| Power density (kW/L) | 0.83 | 1.31 | 1.36 | 1.75 |
| PM utilization (Nm/L) | 203.27 | 231.09 | 221.95 | 288.82 |

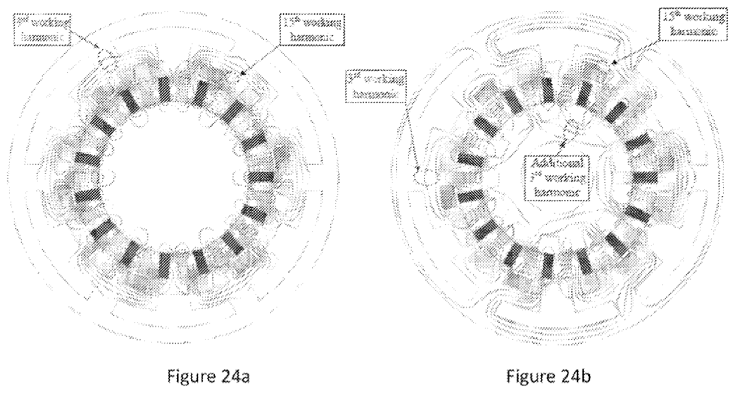

This phenomenon can be explained as follows. The flux lines of the Vernier machine portion of M-IV 1814 without and with the inner rotor are shown in FIG. 19. As can be seen from FIG. 24a, the low-order working harmonic of the machine without the inner rotor, i.e., Qᵢₙ−Pₒᵣ=3 (harmonic), travels through 2 PM pieces and bypass 1 PM piece, or travels through 4 PM pieces and bypass 1 PM piece. Hence, the magnetic reluctance of this magnetic path is very high, which reduces the flux modulation effect and the output torque capability. By contrast, as can be seen from FIG. 24b, besides the aforementioned magnetic path for the 3^{rd} working harmonic, there is an additional magnetic path which travels through 2 PM pieces via the inner rotor core (see the flux lines marked by the blue dotted line). As a result, the flux modulation effect and the output torque capability are improved.

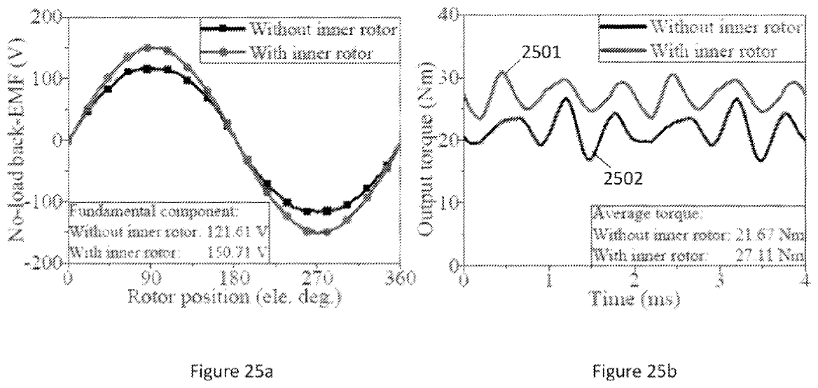

The back-EMF and output torque profiles of the Vernier machine portion of M-IV 1814 without and with the inner rotor, are shown in FIGS. 25a and 25b. FIG. 25b shows output torque of M-IV 1814 with the inner rotor (see 2501) and without the inner rotor (2502). As can be seen, the back-EMF and the output torque of the Vernier machine portion with the inner rotor are significantly improved, compared to those without the inner rotor. More specifically, the fundamental component of the back-EMF is improved by 23.93% from 121.61 V to 150.71 V, and the output torque is improved by 25.10% from 21.67 Nm to 27.11 Nm. These results are in consistent with the theoretical analysis mentioned-above.

Accordingly, it can be concluded that the inner rotor of M-IV 1814 artfully works as not only the additional flux guide/bridge to carry the low-order working harmonic of the Vernier machine portion, but also the flux modulator of the MGM portion.

Overall, compared to the other three candidates, M-IV 1814 exhibits the highest torque/power density (improved by more than 25% compared to the other three candidates, which is a significant improvement), highest efficiency, highest PM utilization, acceptable power factors in both the outer winding and the inner winding. Hence, M-IV 1814 is more suitable for the HEV applications. Accordingly, M-IV 1814 is selected for further optimization and investigation. It should be noted that even though compared to M-I 1811 and M-II 1812, the power factors of the MGM portion of M-III 1813 and M-IV 1814 are improved, all the power factors of the MGM portion of the four investigated machines are still relatively low (see Table IX). This is due to the fact that MGMs with higher gear ratios suffer from higher flux leakage and lower flux density in the air-gap excited by the PMs, and hence higher synchronous reactance and lower power factors.

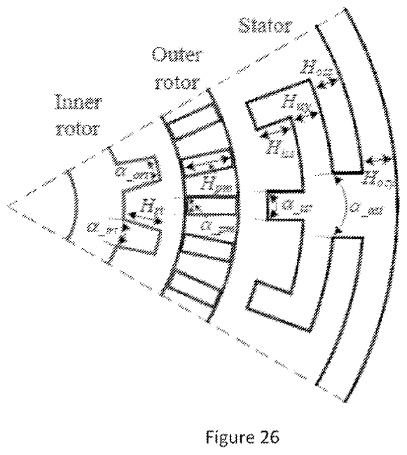

The parametric geometry model of the proposed machine, i.e., the DMP machine 1814 with open slots, is shown in FIG. 26. As can be seen, there are 11 independent design variables involved in a multi-objective optimization, including the outer stator yoke height, H_{osy}, the outer stator slot height, Hₒₛₛ, the outer stator tooth-arc width in degrees, α_ost, the inner stator yoke height, H_{isy}, the inner stator slot height, Hᵢₛₛ, the inner stator tooth-arc width, α_ist, the PM height, Hₚₘ, the PMarc width, αₚₘ, the inner rotor tooth height, Hᵣₜ, the outer tooth-arc width of the inner rotor, α_ort, and the inner tooth-arc width of the inner rotor, α_ir.

The large-scale multi-objective optimization of the proposed machine design is carried out by pursuing the three following objectives simultaneously:

The first objective is maximization of the outer rotor torque and the inner torque given by the expression as follows:

$$Torque objective = \frac{{T}_{o r}}{{T}_{or initial}} + \frac{{T}_{i r}}{{T}_{ir\_initial}} \qquad ( 32 )$$

where Tₒᵣ and Tᵢᵣ are the output torques of the outer rotor and the inner rotor, respectively, while T_{or_initial} and T_{ir_initial} are their corresponding initial values.

The second objective is maximization of the efficiency, η, is given as follows:

$$η = [ \frac{{P}_{out}}{( {P}_{out} + {P}_{copper} + {P}_{core} + {P}_{{P}_{e}} , ddy )} ] \times 100 \% \qquad ( 33 )$$

where Pₒᵤₜ is the output power, P_{copper}, P_{core}, and P_{PM_eddy} are the copper losses, the core losses, and the PM eddy-current losses, respectively.

The third objective is maximization of the outer winding power factor, P_{f_out}.

Meanwhile, two constraints are incorporated in the optimization fitness function with the following goals. The first goal is to restrain the outer rotor torque ripple, T_{rip_or}<30%. The second goal is to restrain the inner rotor torque ripple, T_{rip_ir}<20%.

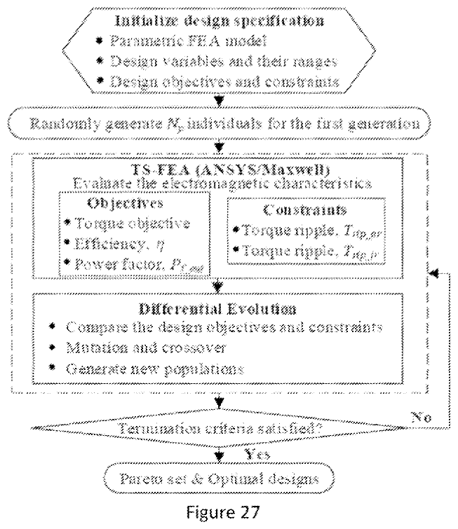

As a metaheuristic optimizer, the differential evolution (DE) optimization algorithm attempts to find a global maximum/minimum by iteratively improving a population of candidate designs until the convergence criteria are satisfied. Differing from other derivative-free population-based evolutionary algorithms, e.g., genetic algorithm, particle swarm optimization, etc., the DE algorithm utilizes a weighted difference between candidate designs to facilitate the improvement of future generations, which has been shown to outperform other stochastic optimization algorithms in terms of the rapidity of convergence, as well as the diversity and high definition of the resulting Pareto fronts. The most basic form of the DE algorithm is the mutation and crossover ideas, i.e., the parameter of a new trail member, uᵢ, is updated by adding the weighted difference between two population vectors to a third vector, which is expressed as follows:

$${u}_{i} = \{ \begin{matrix}{x}_{r 0} + F ( {x}_{r 1} - {x}_{r 2} ) , & if [ rand ( 0 , 1 ) ] \leq {C}_{r} \\ {x}_{i} , & otherwi s e\end{matrix} \qquad ( 34 )$$

where xᵣ₀, xᵣ₁, and xᵣ₂ are three randomly selected presented population members, F is the positive real difference scale factor, Cᵣ is the predefined crossover probability, xᵢ is the parameter of the present population member. The trail vector, u, is allowed to enter the population only if it outperforms the present member, x. The overall optimization procedure is shown in FIG. 27.

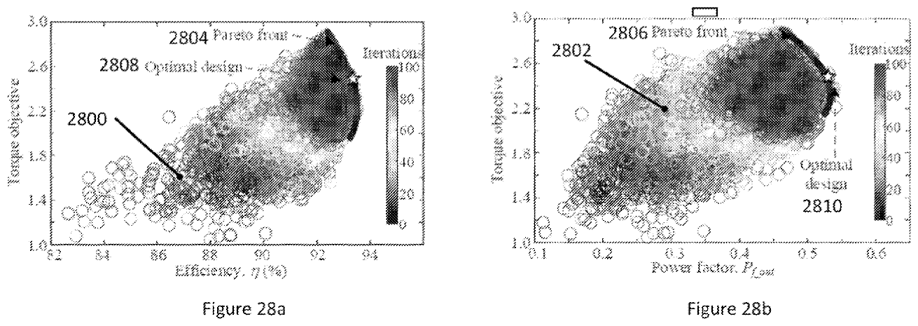

A total of 10,000 designs are explored with 100 iterations and 100 designs per generation. The scatter plot of the objectives from feasible designs is shown in FIGS. 28a and 28b. As can be seen, conflicts exist between these three objectives. As the iteration/generation number increases (from the region generally indicated by 2800 or 2802, towards the Pareto front 2804, 2806 and optimal design 2808, 2810), the candidates converge to the Pareto front. This result indicates that the DE algorithm works effectively for the fulfillment of multiple objectives. An optimal design marked with a black-bordered white star in FIGS. 28a and 28b is selected from the Pareto front based on the best compromise between these three objectives. The main parameters of the optimal design are listed in Table X.

TABLE X

| Parameter | Value | Parameter | Value |
|---|---|---|---|
| H [symbol] (mm) | 9.0 | H [symbol] (mm) | 8.0 |
| α [symbol] | 11.4° | H [symbol] (mm) | 8.3 |
| H [symbol] (mm) | 9.7 | α [symbol] | 6.3° |
| H [symbol] (mm) | 15.0 | α [symbol] | 5.74° |
| H [symbol] (mm) | 13.0 | α [symbol] | 9.0° |
| α [symbol] | 14.0° | — | — |

Electromagnetic performance

| | | | |
|---|---|---|---|
| Eₗ_{_{—}}ₒᵤₜ (V) | 58.31 | Eₗ_{_{—}}ᵢₙ (V) | 162.83 |
| T_{or svg} (Nm) | 48.93 | Tᵣᵢₚ_{_{—}}ₒᵣ (%) | 13.53 |
| T [symbol] _{_{—}}_{avg} (Nm) | −17.66 | Tᵣᵢₚ_{_{—}}ᵢᵣ (%) | 6.44 |
| P_{f}_{_{—}}ₒᵤₜ | 0.53 | P_{f}_{_{—}}ᵢₙ | 0.97 |
| Output power (kW) | 5.12 | Efficiency, η (%) | 93.24 |
| Torque density (Nm/L) | 24.04 | Power density (kW/L) | 1.85 |

[symbol]

indicates data missing or illegible when filed

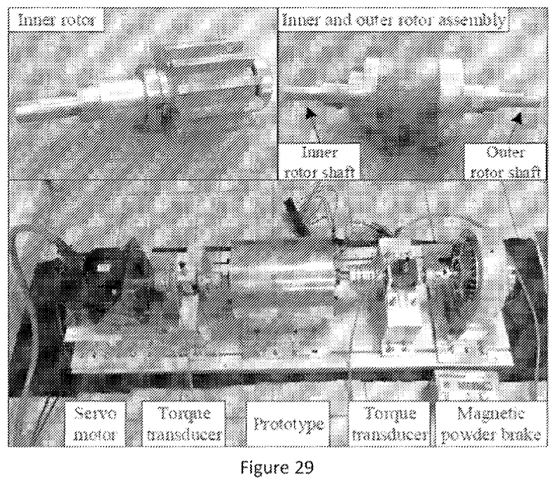

The present invention now discusses experimental validation. The optimal design selected from the previous section is prototyped. The prototype and experimental setup are shown in FIG. 29.

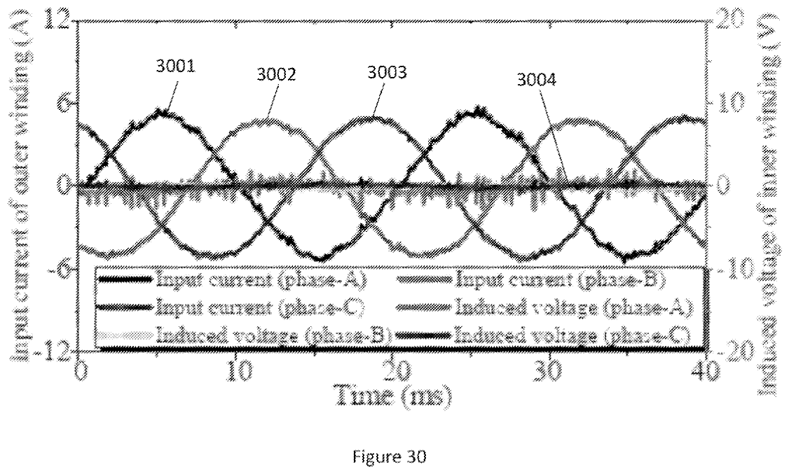

Since there are two sets of windings in the prototype, i.e., the outer winding and the inner winding, validation of the decoupling of the two sets of windings is of paramount importance. When both rotors are at standstill and the outer winding (MGM portion) is excited with 50 Hz, 5 A alternating current (see input current 3001, 3002, 3003 of Phases-A, -B and -C respectively), the measured induced voltages of the inner winding (Vernier machine portion) are shown in FIG. 30. As can be seen, when the outer winding is excited, the induced voltages of the inner winding (as shown at 3004) remain almost zero. This result indicates that the mutual inductance between the two sets of windings is negligible, and the two sets of windings are decoupled. This is due to the fact that the pole-pair combination of the prototype meets the requirement/criterion for the decoupling design of two sets of windings.

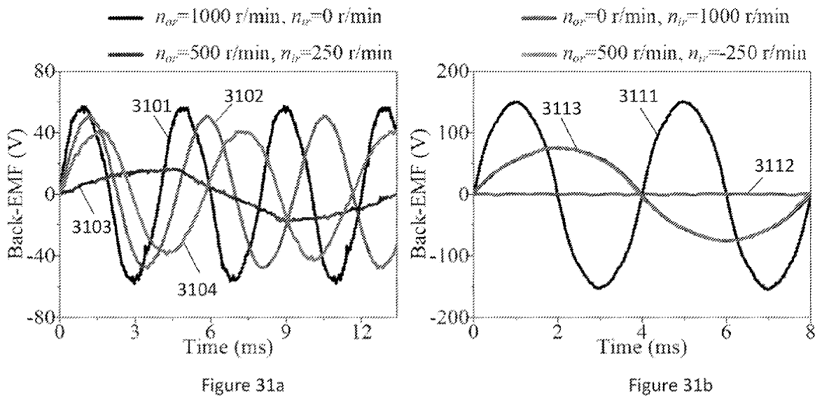

The measured back-EMF profiles with different outer rotor and inner rotor speeds are shown in FIGS. 31a and 31b, respectively. The simulated and measured results are listed in Table XI, where nₒᵣ and nᵢᵣ are the speeds of the outer rotor and the inner rotor, respectively. In particular, in FIG. 31a, 3101 refers to the case when nₒᵣ=1000 r/min and nᵢᵣ=0 r/min, 3102 refers to the case when nₒᵣ=0 r/min and nᵢᵣ=1000 r/min, 3103 refers to the case when nₒᵣ=500 r/min and nᵢᵣ=250 r/min, 3104 refers to the case when nₒᵣ=500 r/min and nᵢᵣ=250/min. In particular, in FIG. 31b, 3111 refers to the case when nₒᵣ=1000 r/min and nᵢᵣ=0 r/min, 3112 refers to the case when nₒᵣ=0 r/min and nᵢᵣ=1000 r/min, 3113 refers to the case when nₒᵣ=500 r/min and nᵢᵣ=250 r/min or when nₒᵣ=500 r/min and nᵢᵣ=250/min. As can be seen, the frequency and the amplitude of the outer winding back-EMF are affected by both the outer and inner rotor speeds, while those of the inner winding back-EMF are only affected by the outer rotor speed. These results are consistent with the theoretical analysis. Moreover, the simulated and measured results are in very good agreement.

TABLE XI

| | | Frequency (Hz) | | Amplitude (V) | |
|---|---|---|---|---|---|
| Cases | Winding | Simulated | Measured | Simulated | Measured |
| nₒᵣ = | outer | 250.00 | 251.26 | 58.31 | 56.99 |
| 1000 r/min | | | | | |
| nᵢᵣ = | inner | 250.00 | 250.00 | 162.81 | 156.30 |
| 0 r/min | | | | | |
| nₒᵣ = | outer | 216.67 | 215.52 | 50.35 | 48.83 |
| 0 r/min | | | | | |
| nᵢᵣ = | inner | — | — | 0.06 | 0.32 |
| 1000 r/min | | | | | |
| nₒᵣ = | outer | 70.83 | 72.63 | 16.56 | 16.13 |
| 500 r/min | | | | | |
| nᵢᵣ = | inner | 125.00 | 125.00 | 81.46 | 78.41 |
| 250 r/min | | | | | |
| nₒᵣ = | outer | 179.17 | 173.61 | 41.67 | 39.65 |
| 500 r/min | | | | | |
| nᵢᵣ = −250 | inner | 125.00 | 125.62 | 81.44 | 78.19 |
| r/min | | | | | |

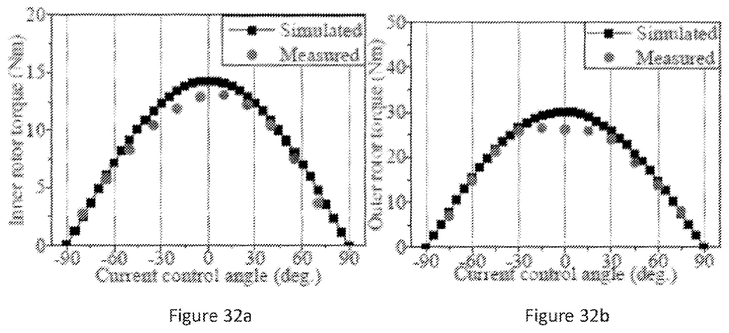

The inner rotor torque versus current control angle with only outer winding excitation where the current amplitude is 20 A is shown in FIGS. 32a, while the outer rotor torque versus current control angle with only inner winding excitation where the current amplitude is 13 A is shown in FIGS. 32b. As can be seen, the maximum torque is achieved near a current control angle equal to zero electrical degree for both the inner and outer rotor torques. This result indicates that the reluctance torques of both the MGM portion and the Vernier machine portion are negligible, and therefore, i_{d}(d-axis current)=0 control method is valid for both the MGM portion and the Vernier machine portion.

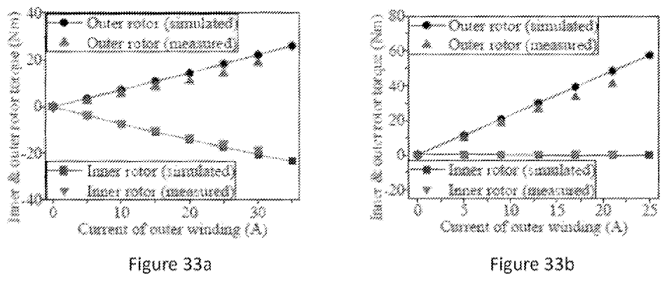

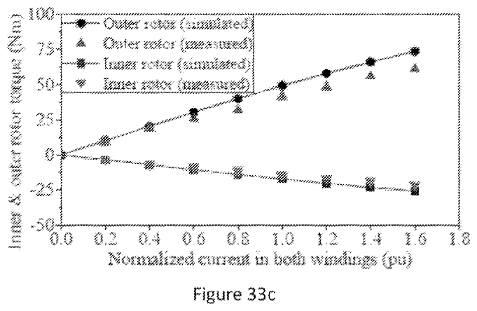

The simulated and measured torques versus the input currents are shown in FIG. 33. As can be seen from FIG. 33a, when only the outer winding is excited, this machine works as a magnetically-geared machine. More specifically, both the outer and inner rotor torques are proportional to the outer winding current. Meanwhile, the outer rotor torque and the inner rotor torque maintain a stationary ratio, i.e., Tor_{avgl} T_{ir_avg}=Pₒᵣ/Pᵢᵣ=15/13. By contrast, as can be seen from FIG. 33b, when the only inner winding is excited, this machine works as a Vernier PM machine. More specifically, the outer rotor torque is proportional to the inner winding current, while the inner rotor torque maintains to be zero. It should be noted that in FIG. 33c, the currents are normalized with respect to the base/rated values of 18 A and 9 A for the outer winding and the inner winding, respectively. As can be seen, when both sets of windings are excited, this machine works an integrated machine which combines both a magnetically-geared machine and a Vernier PM machine. Moreover, the simulated and measured torques are in acceptable agreement.

In general, embodiments of the present invention also introduce a new DMP electric machine for the CVT-based HEV applications. To comprehensively and quantitatively evaluate the pros and cons of the proposed machine, a comparative study of four DMP electric machines with different topologies is conducted. These four investigated DMP electric machines include a conventional DMP machine (M-I 1811), a DMP machine with spoke-type PMs (M-II 1812), a DMP machine with reluctance rotor (M-III 1813), and a DMP machine with open slots which is the proposed machine in this disclosure (M-IV 1814). It was revealed that even though these machines have similar topologies, they have different operating principles. Moreover, the performance metrics of these four machines evolve and progressively go forward from M-I 1811 to M-II 1812 to M-III 1813 to M-IV 1814. More specifically, compared to the conventional machine (M-I 1811), the torque density of M-II 1812 is improved by using spoke-type PMs in the outer rotor. Compared to M-II 1812, the outer winding power factor, the efficiency, and the power density of M-III 1813 are improved by using a reluctance inner rotor.

Differing from the other three machines, M-IV 1814 works in an artful manner, i.e., this machine works as an integrated machine which combines both a magnetically-geared machine and a Vernier PM machine. Due to the “dual flux-modulation” phenomenon involved in this machine, M-IV 1814 exhibits significantly improved torque/power density and efficiency. Then, a largescale multi-objective optimization of the proposed machine (M-IV 1814) was carried out using the metaheuristic differential evolution optimization algorithm. An optimal design was obtained for prototyping from the Pareto fronts. The experimental results verified the effectiveness of the analysis and simulation results in this disclosure. The proposed DMP machine 1814 is suitable for HEV applications, particularly in the power-split continuously variable transmission systems, which (torque and speed for maximum efficiency or minimum emission) indifferent to the vehicle speed.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

13. An apparatus comprising:
a magnetic-geared machine component; and
a Vernier machine component;
wherein the magnetic-geared machine component is arranged concentrically with the Vernier machine component; and
wherein each of the magnetic-geared machine component and the Vernier machine component have flux modulation functionality.

14. An apparatus according to claim 13, comprising:
a stator comprising an outer stator that comprises outer stator teeth having at least one first winding arranged thereon, and an inner stator that comprises inner stator teeth having at least one second winding arranged thereon; and
a rotor comprising an outer rotor that comprises a plurality of permanent magnets alternating with a plurality of steel segments, and an inner rotor about which the outer rotor is arranged.

15. The apparatus according to claim 14, wherein the plurality of permanent magnets are circumferentially magnetized and polarity of the plurality of permanent magnets alternates around the rotor.

16. An apparatus according to claim 14, wherein the magnetic-geared machine component comprises the at least one first winding, the plurality of permanent magnets of the outer rotor, and the inner rotor; and wherein the Vernier machine component comprises the at least one second winding, the inner stator teeth, and the outer rotor.

17. An apparatus according to claim 14, wherein salient poles of the inner rotor provide the flux modulation functionality of the magnetic-geared machine component.

18. An apparatus according to claim 14, wherein the inner stator teeth provide the flux modulation functionality of the Vernier machine component.

19. An apparatus according to claim 18, wherein the inner stator comprises inner stator slots that are open slots.

20. An apparatus according to claim 14, wherein the inner stator teeth comprise open slot teeth.

21. An apparatus according to claim 14, wherein the at least one first winding is decoupled from the at least one second winding.

22. An apparatus according to claim 21, wherein a pole-pair number of each first winding differs from a pole-pair number of each second winding.

23. An apparatus according to claim 14, wherein the inner rotor and the outer rotor are connected to respective sets of wind turbine blades.

24. A flux modulation apparatus comprising:
a stator comprising outer stator teeth having at least one first winding arranged thereon and inner stator teeth comprises at least one second winding arranged thereon;
an outer rotor comprising a plurality of permanent magnets alternating with a plurality of steel segments; and
an inner rotor about which the outer rotor is arranged,
wherein the at least one first winding, the plurality of permanent magnets and the inner rotor form a magnetic-geared machine component, and the at least one second winding, the inner stator teeth and the outer rotor form a Vernier machine, and wherein each of the magnetic-geared machine component and the Vernier machine component have flux modulation functionality.

25. The apparatus according to claim 24, wherein the plurality of permanent magnets are circumferentially magnetized and polarity of the plurality of permanent magnets alternates around the rotor.

26. An apparatus according to claim 24, wherein salient poles of the inner rotor provide the flux modulation functionality of the magnetic-geared machine component.

27. An apparatus according to claim 24, wherein the inner stator teeth provide the flux modulation functionality of the Vernier machine component.

28. An apparatus according to claim 27, wherein the inner stator comprises inner stator slots that are open slots.

29. An apparatus according to claim 24, wherein the inner stator teeth comprise open slot teeth.

30. An apparatus according to claim 24, wherein the at least one first winding is decoupled from the at least one second winding.

31. An apparatus according to claim 30, wherein a pole-pair number of each first winding differs from a pole-pair number of each second winding.

32. An apparatus according to claim 24, wherein the inner rotor and the outer rotor are connected to respective sets of wind turbine blades.
